(19) United States
(12) Patent Application Publication
(10) Pub. No.: US 2016/0317264 A1
(43) Pub. Date: Nov. 3, 2016

(54) System and Method for Recording a Bite of an Edentulous Individual

(71) Applicant: TRISPERA DENTAL INC., Calgary (CA)

(72) Inventors: Erin Lenore Derraugh, Calgary (CA); Steve Cowburn, Calgary (CA); George Cowburn, Calgary (CA)

(21) Appl. No.: 15/106,148

(22) PCT Filed: Dec. 19, 2014
(86) PCT No.: PCT/CA14/51244

§ 371 Date: Jun. 17, 2016

Related U.S. Application Data
(60) Provisional application No. 61/917,987, filed on Dec. 19, 2013.

(51) Int. Cl. A61C 13/34; A61C 9/00; A61C 13/00; A61C 19/05

(52) U.S. Cl. CPC A61C 13/34; A61C 19/052; A61C 9/0053; A61C 13/0004

(57) ABSTRACT

A method and system for determining a bite of an edentulous individual. The individual's maxillary and mandibular dental arches are scanned to provide first data for preparing a model of the arches. A pair of trays with bite establishment components positioned on each of the trays are held in the individual's mouth with the arches received within the trays to define a maxillomandibular relationship corresponding to a bite position. The trays include apertures for exposing each of the arches to provide a continuous scanning path between the arches. The arches, and a continuous path between the arches, are each scanned while the trays are held in the individual's mouth to provide second data for preparing a model of relative positions of the arches at the bite position. The first and second data may be combined to prepare a model of the arches with empirical data of the bite position.

### CROSS REFERENCE TO RELATED APPLICATIONS

This application claims the benefit of priority of U.S. Provisional Patent Application No. 61/917,987 filed Dec. 19, 2013, which is hereby incorporated by reference.

### FIELD

The present disclosure relates generally to recording bites of edentulous individuals.

### BACKGROUND

The relative position of an individual's maxillary (upper) and mandibular (lower) dental arches is a maxillomandibular relationship. Maxillomandibular relationships include occlusion (interdigitation) between some or all of the individual's teeth, commonly referred to as a “bite”, a position of centric occlusion, or a position of centric relation. Various methods are used to record a bite from individuals who are fully or partially dentate. The static positions of teeth, implants, or both, are required for reliable and repeatable contact with each other.

A bite can be recorded either by using registration material or an optical scanner. An optical scanner may be used to scan the arches individually, and the teeth or implants, in one or more positions where the teeth or implants contact each other. The arches are aligned with each other using modelling software, generating a model which of maxillomandibular relationships of an individual, and is used for purposes of diagnosis and/or design of dental restorations and/or prostheses. The scanner may be, for example, a 3Shape Trios intraoral scanner.

U.S. publication no. 2013/0218530 discloses a method by which a 2D extraoral image is superimposed on a 3D intraoral model for the purposes of analyzing existing dentition and visualizing proposed restorations and prosthetic designs. The disclosure is related to capturing natural dentition and creating visualizations of possible restorations and modifications.

U.S. publication no. 2013/0209962 discloses a method of using an individual's existing dentures to create replicas for an esthetic guide and to record a maxillomandibular relationship. Arch information is derived from impressions of the gums, either in the denture, or taken separately in an impression tray. Maxillomandibular relationships are recorded by employing a bite registration material which is placed on the teeth in a bite position to secure the two dentures together. The dentures are removed from the mouth and scanned, retained by the bite registration material, as one unit. Alternatively, the upper denture, lower denture, and bite registration material may be scanned separately, and the resulting digital models aligned with software.

U.S. publication no. 2013/0209962 describes a technique of using impression material inside an individual's existing dentures to stabilize the dentures and restore proper load distribution on the gums. Following this, much like the method described by U.S. publication no. 2012/0322031, the arch impressions are combined with the maxillomandibular registration. Compared to a pin tracer method, impression-based recording of the maxillomandibular relationship is more arbitrary, as material is injected on top of the existing denture teeth, then the individual bites down, until the material hardens. This bite registration material is then removed from the denture teeth, and scanned separately by a desktop scanner. The upper and lower dentures are removed and scanned individually. In the rendering software, the upper and lower dentures are meshed to the scan of the bite registration material and a compound model is created.

Intraoral and extraoral gothic pin tracers are described in many issued patents, published patent applications, scientific publications, trade journals, and textbooks. Earliest examples go back more than 100 years. Intraoral tracers, also referred to as intraoral gothic arch registration devices, are disclosed in U.S. Pat. No. 1,764,115, U.S. Pat. No. 2,447,287, U.S. Pat. No. 2,582,104, U.S. Pat. No. 5,186,624, and U.S. Pat. No. 6,152,730. More recent examples are shown in U.S. publication no. 2013/0280672 and U.S. publication no. 2012/0322031. Extraoral tracers follow similar principles and are described by U.S. Pat. No. 5,722,828.

A pin tracer will include custom bases which rest on the upper and lower arches, including on any combination of teeth, implants or gums. A pin is secured to one arch and a recording plate secured to the opposing arch. The individual's movements are illustrated by markings made by the pin on the recording plate. The markings may be used to identify and record certain maxillomandibular relationships. The resultant tracing is used to determine a maxillomandibular position in which the individual is in centric relation. The centric relation position is then locked in place and the device removed. Traditionally, a pin tracer was used to physically hold dental models which are then secured in position to a dental articulator.

Centric record is defined in Nallaswamy, Deepak (2011) Textbook of Prosthodontics (ISBN 81-8061-199-X) at p. 844 as follows: “The maxillomandibular relationship in which the condyles articulate with the thinnest avascular portion of their respective disks with the complex in the anterior-superior position against the shapes of the articular eminences. This position is independent of tooth contact. This position is clinically discernible when the mandible is directed superiorly and anteriorly. It is restricted to a purely rotary movement about the transverse horizontal axis.”

Gothic tracers communicate positional information (e.g. how open or closed the jaws are etc.) and desirable maxillomandibular relationship. This information facilitates diagnosis, analysis, or design of restorations and prosthetics. In essence, a pin tracer maintains separation between arches and allows a partially or completely edentulous individual to bite and make jaw movements with minimal contact and no interferences to identify a desirable maxillomandibular position.

Due to the varying shapes and sizes of an individual's soft tissues, which the pin tracer device rests on, an intermediary material is used to improve the fit and stability of the tissue-fitting portions of the pin tracer device. Impression materials or intraoral putty may be used. The tissue-fitting sides of pin tracer devices may be perforated to allow mechanical retention of these intermediary materials. During taking of the impression and hardening of the material, it flows through the perforations and engages the pin tracer device. As a result, the material must be torn to be removed, providing resistance to accidental removal of the material from the pin tracer.

Use of a pin tracer includes adjusting the pin up or down to achieve a maxillomandibular relationship in centric relation. From this position, jaw movements are traced by the pin contacting the recording plate. Free of pathology, this procedure commonly results in a triangular, arrowhead shape. The apex of the aforementioned arrowhead is used to identify the centric relation position. At this position, the upper and lower parts of the device should be connected to each other to translate the desired maxillomandibular relationship to an articulator. The pin is secured to the recording plate in the centric relation position, for example by securing a recording plate with a hole in it to the recording plate portion of the device. The hole in the attached recording plate is the same size as the pin and only allows full closure of the bite in the centric relation maxillomandibular position. The pin may also be secured to the recording plate by injecting bite registration material into the void between the upper and lower portions of the device. While the material hardens, the individual holds the centric relation position. This allows the two parts of the device to be removed, either together in one piece, or separately, then reassembled and realigned following removal. The pin may also be secured to the recording plate by bridging the upper and lower portions of the pin tracer to each other with a mechanical connection.

Once the pin and recording plate are secured to each other, the pin tracer is removed from the mouth and used to transfer the maxillomandibular information to a dental articulator (either physical or virtual). For positioning casts in a virtual environment, the procedure involves scanning the pin tracer device using a 3D scanner, either by scanning the upper and lower portions as they are locked together, or by scanning both upper and lower portions separately and aligning the two halves in software. The tissue fitting sides of the device are used to align to existing virtual models of the upper and lower gums. Alternatively, a single-step method involves scanning the impression material inside the upper and lower portions of the device, to create upper and lower models. These models are then aligned in a virtual environment, as previously described.

Dental models and pin tracing device can be scanned using a desktop 3D scanner (e.g. the Dental Wings scanner, the 3Shape desktop scanner, etc.). The 3D rendered models are imported into software for modeling and design of dental restorations, prostheses and dentures as described by applications U.S. publication no. 2013/0218532 and international publication no. WO 2012/041329. These techniques use traditional impressions of the upper and lower arches, which are then scanned, or by pouring dental stone/gypsum into the impressions, models can be created and the resultant casts can also be scanned. The method described in U.S. publication no. 2012/0322031 combines the arch impression with the pin tracer device. The method described by U.S. publication no. 2013/0280672 uses two separate procedures to record maxillomandibular information: traditional impressions for recording the arch impressions and a separate pin tracer device. These two sources of data are scanned and the resultant models rendered, are combined or meshed, in software, and are used in diagnosis and/or design of dentures and/or other dental restorations.

### SUMMARY

Establishing a maxillomandibular relationship corresponding to a bite position in an edentulous individual by previous methods often includes obtaining a bite registration cast of the individual's arches and 3D scanning the registration material. Such methods include inherent inaccuracy in bite registration and it is therefore desirable to mitigate these inaccuracies.

Herein disclosed are methods and systems for recording data of a maxillomandibular relationship corresponding to a bite position of an edentulous individual. The data facilitates preparing a model including empirical data of the individual's maxillomandibular relationship at the bite position. The methods include and the systems facilitate scanning the individual's arches to provide first data for modelling the arches, and scanning the arches at the bite position to provide second data for modelling the relative positions of the arches at the bite position based on empirical data. The bite position is established by including a pair of trays in the individual's mouth during acquisition of the second data. Preparing a cast from bite registration material is unnecessary when applying the methods and systems disclosed herein.

The trays are shaped to receive the arches and include complementary bite establishment components, such as dentition, or a pin and recording plate to provide pin tracer functionality, to define the bite position. The trays may for example be a copy of the individual's dentures with some or all of the included on the individual's existing denture dentition, or a pin tracer or other bite recording device, which may include some dentition. The trays include apertures to expose each of the arches, providing a continuous scanning path between the arches when the trays are held in the individual's mouth. Visible portions of the arches, and the continuous path between the arches, are scanned to provide the second data. The second data is combined with the first data to create a single compound model of both arches with empirical data of the bite position.

The methods and systems disclose herein facilitate designing or modifying of dentures, and obtaining a maxillomandibular relationship, without the use of impression or bite registration materials. Advantages may result, including mitigating inherent inaccuracies of impression materials, reducing cost, reducing the required time, or reducing the required expertise to establish a bite position.

In a first aspect, the present disclosure provides a method and system for determining a bite of an edentulous individual. The individual's maxillary and mandibular dental arches are scanned to provide first data for preparing a model of the arches. A pair of trays with bite establishment components positioned on each of the trays are held in the individual's mouth with the arches received within the trays to define a maxillomandibular relationship corresponding to a bite position. The trays include apertures for exposing each of the arches to provide a continuous scanning path between the arches. The arches, and a continuous path between the arches, are each scanned while the trays are held in the individual's mouth to provide second data for preparing a model of relative positions of the arches at the bite position. The first and second data may be combined to prepare a model of the arches with empirical data of the bite position.

In a further aspect, the present disclosure provides a method of acquiring data for preparing a model of an edentulous individual including acquiring first data of a maxillary arch of the individual and of a mandibular arch of the individual for modelling the maxillary arch and the mandibular arch; providing a pair of components for receiving the maxillary arch and the mandibular arch in a maxillomandibular relationship defining a bite position, the pair of components defining apertures on each of the components for exposing a continuous path between the maxillary arch and the mandibular arch; and acquiring second data along the continuous path of the maxillary arch and the mandibular arch in the bite position for modelling the relative positions of the maxillary arch and the mandibular arch in the bite position.

In an embodiment, the apertures are aligned on corresponding surfaces of each of the components.

In an embodiment, the method includes combining the first data and the second data to prepare the model, the model including empirical data of the bite position.

In an embodiment, the method includes providing appliance data of a pair of dentures and combining the first data, the second data, and the appliance data to prepare the model, the model including empirical data of the bite position. In an embodiment, providing the appliance data includes scanning a pair of dentures fitted to the individual.

In an embodiment, the method includes providing appliance data of a pair of dentures and combining the first data, the second data, and the appliance data to prepare the model, the model including empirical data of the bite position. In an embodiment, providing the appliance data includes accessing a library of appliance data.

In an embodiment, the method includes acquiring third data of the pair of components for modelling the pair of components. In an embodiment, the method includes combining the first data, the second data, and the third data to prepare the model, the model including empirical data of the bite position and of the pair of components.

In an embodiment, the method includes acquiring fourth data of external features of the individual for modelling the external features. In an embodiment, the method includes combining the first data, the second data, and the fourth data to prepare the model, the model including empirical data of the bite position and of the external features at the bite position.

In an embodiment, the method includes acquiring fourth data of external features of the individual for modelling the external features. In an embodiment, acquiring the fourth data further includes acquiring the fourth data while the individual maintains a selected facial expression to prepare a model with empirical data of the external features at the selected facial expression.

In an embodiment, the second data further includes data of external features of the individual for modelling the relative positions of the maxillary arch and the external features.

In an embodiment, acquiring the second data includes exposing the apertures with a cheek retractor.

In an embodiment, providing the pair of components includes preparing a replica of dentures prepared for the individual and the apertures are defined on the replica.

In an embodiment, the method includes locking the pair of components in the bite position.

In an embodiment, the pair of components includes a recorder and a recording surface. In an embodiment, the method includes defining the bite position with reference to markings made on the recording surface by the recorder.

In an embodiment, the method includes providing a bridge between the pair of components proximate the apertures for providing a frame of reference along a portion of the continuous path located between the pair of components. In an embodiment, providing a bridge between the pair of components proximate the apertures include connecting the pair of components with deformable material.

In an embodiment, the method includes providing a bridge between the pair of components proximate the apertures for providing a frame of reference along a portion of the continuous path located between the pair of components. In an embodiment, providing a bridge between the pair of components proximate the apertures includes moving a bridging component connected to the pair of components from a closed position to a bridging position.

In an embodiment, acquiring the first data includes scanning the arches with an intraoral scanner.

In an embodiment, acquiring the first data includes scanning the arches with an extraoral scanner.

In an embodiment, acquiring the first data includes scanning the arches with an optical scanner.

In an embodiment, acquiring the first data includes scanning the arches with an ultrasonograph.

In an embodiment, acquiring the second data includes scanning the arches along the continuous path with an intraoral scanner.

In an embodiment, acquiring the second data includes scanning the arches along the continuous path with an extraoral scanner.

In an embodiment, acquiring the first data includes scanning the arches along the continuous path with an optical scanner.

In an embodiment, acquiring the first data includes scanning the arches along the continuous path with an ultrasonograph.

In a further aspect, herein provided is a bite registration apparatus including a maxillary component shaped for receiving a maxillary arch; a mandibular component shaped for receiving a mandibular arch; bite establishment components located on facing portions of the maxillary component and the mandibular component for defining a bite between the maxillary component and the mandibular component; and a maxillary aperture defined on the maxillary component and a mandibular aperture on the mandibular component for exposing to scanning a continuous path between a maxillary arch received within the maxillary component and a mandibular arch received within the mandibular component.

In an embodiment, the maxillary aperture and the mandibular aperture are defined on corresponding surfaces of the maxillary component and of the mandibular component. In an embodiment, the corresponding surfaces are on facial walls of the maxillary component and of the mandibular component.

In an embodiment, the maxillary aperture and the mandibular aperture are defined on corresponding surfaces of the maxillary component and of the mandibular component. In an embodiment, the corresponding surfaces are on buccal walls of the maxillary component and of the mandibular component.

In an embodiment, the maxillary aperture and the mandibular aperture are defined on corresponding surfaces of the maxillary component and of the mandibular component. In an embodiment, the corresponding surfaces are on lingual walls of the maxillary component and of the mandibular component.

In an embodiment, the maxillary aperture and the mandibular aperture are defined on corresponding surfaces of the maxillary component and of the mandibular component. In an embodiment, the corresponding surfaces are on lingual walls of the maxillary component and of the mandibular component.

In an embodiment, the apparatus includes a bridge extending between the the maxillary component proximate the maxillary aperture and the mandibular component proximate the mandibular aperture for providing a frame of reference along the continuous path between the maxillary component and the mandibular component. In an embodiment, the bridge includes a bridge component movable between a closed position and a bridging position. In an embodiment, the bridge component is hingedly, pivotally, or slidably connected to the bite registration apparatus.

In an embodiment, the apparatus includes a bridge extending between the the maxillary component proximate the maxillary aperture and the mandibular component proximate the mandibular aperture for providing a frame of reference along the continuous path between the maxillary component and the mandibular component. In an embodiment, the bridge includes a bridge component movable between a closed position and a bridging position. In an embodiment, the bridge includes a single bridge component connected to the maxillary component or to the mandibular component.

In an embodiment, the apparatus includes a bridge extending between the the maxillary component proximate the maxillary aperture and the mandibular component proximate the mandibular aperture for providing a frame of reference along the continuous path between the maxillary component and the mandibular component. In an embodiment, the bridge includes a bridge component movable between a closed position and a bridging position. In an embodiment, the bridge includes a first bridge component extending from the maxillary component and a second bridge component extending from the mandibular component.

In an embodiment, the apparatus includes a bridge extending between the the maxillary component proximate the maxillary aperture and the mandibular component proximate the mandibular aperture for providing a frame of reference along the continuous path between the maxillary component and the mandibular component. In an embodiment, the bridge includes a bridge component movable between a closed position and a bridging position. In an embodiment, the bridge component reversibly covers at least one of the apertures.

In an embodiment, the complementary bite establishment components include dentition extending from the maxillary component and from the mandibular component.

In an embodiment, the complementary bite establishment components include a recording surface and an opposed recorder for marking the recording surface. In an embodiment, the recorder extends from the mandibular component and the recording surface is located on the maxillary component.

In an embodiment, the complementary bite establishment components include dentition.

In a further aspect, the present disclosure provides a method of acquiring data for preparing a model of an edentulous individual including acquiring first data of a maxillary arch of the individual and of a mandibular arch of the individual for modelling the maxillary arch and the mandibular arch; providing a pair of components for receiving the maxillary arch and the mandibular arch in a maxillomandibular relationship defining a bite position, the pair of components defining apertures on each of the components for exposing a continuous path between the maxillary arch and the mandibular arch; and acquiring second data along the continuous path of the maxillary arch and the mandibular arch in the bite position for modelling the relative positions of the maxillary arch and the mandibular arch in the bite position. The pair of components include a bite registration apparatus including a maxillary component shaped for receiving a maxillary arch; a mandibular component shaped for receiving a mandibular arch; bite establishment components located on facing portions of the maxillary component and the mandibular component for defining a bite between the maxillary component and the mandibular component; and a maxillary aperture defined on the maxillary component and a mandibular aperture on the mandibular component for exposing to scanning a continuous path between a maxillary arch received within the maxillary component and a mandibular arch received within the mandibular component.

In a further aspect, the present disclosure provides the present disclosure provides a method of acquiring data for preparing a model of an edentulous individual including acquiring first data of a maxillary arch of the individual and of a mandibular arch of the individual for modelling the maxillary arch and the mandibular arch; providing a pair of components for receiving the maxillary arch and the mandibular arch in a maxillomandibular relationship defining a bite position, the pair of components defining apertures on each of the components for exposing a continuous path between the maxillary arch and the mandibular arch; and acquiring second data along the continuous path of the maxillary arch and the mandibular arch in the bite position for modelling the relative positions of the maxillary arch and the mandibular arch in the bite position, the pair of components including a recorder and a recording surface. The pair of components include a bite registration apparatus include a maxillary component shaped for receiving a maxillary arch; a mandibular component shaped for receiving a mandibular arch; bite establishment components located on facing portions of the maxillary component and the mandibular component for defining a bite between the maxillary component and the mandibular component; a maxillary aperture defined on the maxillary component and a mandibular aperture on the mandibular component for exposing to scanning a continuous path between a maxillary arch received within the maxillary component and a mandibular arch received within the mandibular component; and a recording surface and an opposed recorder for marking the recording surface

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached figures, in which features sharing reference numerals with a common final two digits of a reference numeral correspond to similar features across multiple figures (e.g. the maxillary aperture 42, 142, 242, 342, 442, 542, 642, 742, 842, 942, and 1042, etc.).

FIG. 1 is an edentulous individual;

FIG. 2 is the individual of FIG. 1 with a pair of trays in their mouth to define a bite;

FIG. 3 is a flow chart of a scanning method for acquiring data;

FIG. 4 is a schematic of acquisition of data by the method of FIG. 3;

FIG. 5 is a flow chart of a processing method for assembling the data acquired by applying the method of FIG. 3 into 3D models;

FIG. 6 is a schematic of the components of the 3D models of FIG. 5;

FIG. 7 is a replica of a denture;

FIG. 8 is the replica of FIG. 7 in a mouth of the individual of FIG. 1;

FIG. 9 is a flow chart of a scanning method for acquiring data;

FIG. 10 is a schematic of acquisition of data by the method of FIG. 9;

FIG. 11 is a flow chart of a processing method for assembling the data acquired by applying the method of FIG. 9 into a 3D model;

FIG. 12 is a schematic of the components of the 3D model of FIG. 11;

FIG. 13 is a pin tracer with buccal facial apertures;

FIG. 14 is a pin tracer with a bridge between maxillary and mandibular components of the pin tracer;

FIG. 15 is a pin tracer with a mandibular bridge component;

FIG. 16 is the pin tracer of FIG. 15 with maxillary and mandibular bridge components in bridging positions;

FIG. 17 is the pin tracer of FIG. 16 with the mandibular bridge component removed;

FIG. 18 is a pin tracer with maxillary and mandibular bridge components;

FIG. 19 is the pin tracer of FIG. 18 with the mandibular bridge component in a bridging position;

FIG. 20 is the pin tracer of FIG. 18 with the mandibular bridge component removed;

FIG. 21 is a pin tracer with maxillary and mandibular bridge components in a bridging position;

FIG. 22 is a pin tracer with maxillary and mandibular bridge components;

FIG. 23 is the pin tracer of FIG. 22 with a mandibular bridge component in a bridging position;

FIG. 24 is the pin tracer of FIG. 22 with the mandibular bridge component removed;

FIG. 25 is the pin tracer of FIG. 13 with material between maxillary and mandibular components;

FIG. 26 is a custom pin tracer including custom dentition;

FIG. 27 is a flow chart of a scanning method for acquiring data;

FIG. 28 is a schematic of acquisition of data by the method of FIG. 27;

FIG. 29 is a flow chart of a processing method for assembling the data acquired by applying the method of FIG. 27 into a 3D model;

FIG. 30 is a schematic of the components of the 3D model of FIG. 29;

FIG. 31 is a replica of a denture;

FIG. 32 is a pin tracer with buccal facial apertures;

FIG. 33 is a pin tracer with buccal lingual apertures;

FIG. 34 is a pin tracer with labial facial apertures; and

FIG. 35 is a pin tracer with labial lingual apertures.

### DETAILED DESCRIPTION

Establishing a maxillomandibular relationship often includes obtaining a bite registration and 3D scanning the registration material or intraorally scanning portions of the maxillary and mandibular teeth while they are in a given occlusion or contact. Any static intraoral structures may serve as landmarks for these registrations (e.g. natural teeth, restored dentition, implant supported restorations, etc.). Without these structures, obtaining a meaningful bite registration is complicated. This is particularly apparent in individuals with complete loss of dentition or loss of posterior dentition, where the individual lacks premolar and/or molar teeth. Establishing a maxillomandibular position based on only anterior tooth contact would likely result in a maxillomandibular relationship that is undesirable for analysis and design. For a totally edentulous individual (an individual who has no teeth; either natural, restored, or implant supported), there are no static reference points to align maxillary structures to mandibular structures. In some cases, a pin tracer and impression material are used, or intermediary structures are placed on the gums, to record the maxillomandibular relationship.

A method is required to record the maxillomandibular relationships of an edentulous individual without teeth or implants, or substantially without teeth or implants, as such individuals have no stable or static reference points to align the maxillary and mandibular arches to each other. The method should facilitate positioning the individual's mandible to a selected maxillomandibular relationship such as a bite position. Data of the relative positions of the maxillary arch and the mandibular arch can then be recorded, for example by an optical scanner or an ultrasonographic scanner.

Herein provided are methods and systems for acquiring data which facilitate modelling an edentulous individual in a maxillomandibular relationship which defines a bite position. The individual's maxillary and mandibular arches are scanned, providing first data which may be used to model each of the arches.

The bite position may be established using a pair of trays with bite establishment components on facing portions of each of the trays for establishing the bite position. By trays, it is meant any component contoured or otherwise shaped to receive either a maxillary arch or a mandibular arch. The bite establishment components may include dentition based on existing dentures, a pin and recording plate combination which together provide a pin tracer, other recorders in combination with recording surfaces, or any suitable features which contact each other in a bite position. Facing portions of the trays face each other when the trays are received in the individual's mouth, for example a maxillary buccal lingual surface may face a mandibular buccal lingual surface. The trays include apertures for exposing the maxillary and mandibular arches received within the trays. The apertures provide a continuous path between the arches received within the trays, facilitating acquiring data of both arches in a single continuous data acquisition sweep from one of the arches, along the continuous path, and to the other arch, without interruption of data acquisition. The apertures may include a window or other transparent cover if the scanning technique used will remain effective through the transparent cover. However, many scanning systems may give greater performance when an unobstructed view is given to the maxillary and mandibular arches. As a result, in addition to simplifying construction of the trays, leaving the apertures free of any transparent cover may improve performance of scanners used with the trays.

First data of each of the maxillary and mandibular arches is acquired, for example with an intraoral scanner (e.g. optical scanners, ultrasonographic scanners, etc.). The first data may be used to model each of the arches. The 3Shape Trios scanner is an example of an intraoral scanner which may be applied in these methods.

Second data of the maxillary and mandibular arches is acquired along the continuous path between the maxillary and mandibular arches while the maxillomandibular relationship is in the bite position for modelling the relative positions of the maxillary arch and the mandibular arch at the bite position. Scanning may be accomplished with either an intraoral scanner or an extraoral scanner (e.g. optical scanners, ultrasonographic scanners, etc.). The 3DMDynamic 4D System extraoral scanner may also be applied in these methods and systems.

Scanning may provide benefits over using impression material in terms of accuracy and time efficiency. Intraoral scanners typically record many data captures, which may be used to create a 3D model. The scanner is then moved, creating an overlap of the previously created 3D model. A new data capture is recorded and both the first 3D model and the new 3D model are meshed to each other, to create a single compounded model. The first data includes sufficient data captures of the maxillary and mandibular arches to model the surfaces of the arches on which dentures or other trays will rest when used by the individual. The second data includes sufficient data captures of the maxillary and mandibular arches, through the apertures, and of the continuous path between the maxillary and mandibular arches, to provide empirical data of the bite position. Extraoral scanners may be used similarly, potentially in conjunction with cheek retractors or other instruments to provide a clear field of view to the maxillary and mandibular arches, and may additionally be used to scan external features of the individual, which may respond to smiles and other facial expressions which may accompany the bite position or other maxillomandibular relationships.

Replicas of existing dentures may be used as the trays. The replicas are prepared by scanning the existing dentures and 3D printing the replica in a suitable material. The apertures would be included in the replicas. The bite establishment components would include some or all of the dentition in the dentures and the exposed portions of the maxillary and mandibular arches may be scanned along the continuous path to establish a relationship between the maxillary and mandibular arches at the bite position.

The trays may include a recorder and a recording surface (e.g. a pin recording plate as used in pin tracers, digital recorders and recording surfaces, etc.), effectively allowing the trays to function as a pin tracer to define the bite position or other maxillomandibular relationships positions. The bite establishment components would include the pin and recording plate.

Scanning the arches provide advantages over using traditional impression material. Impression material-based techniques have known drawbacks including tissue compression, errors caused by improper size/shape of impression trays, distortion of the impression material caused by movement during the impression process, distortion of the material during the setup or hardening process, and bubbles in the material causing regional loss of data. If casts are prepared by pouring dental stone/gypsum into the impressions, models based on the casts are subject to the same distortion, and the dimensional proportions of gypsum dental models would be further affected by moisture content. The dimensional fidelity of the arches is affected by these compounding errors resulting from the impression material, impression taking technique, stone/gypsum material properties and inherent inaccuracies of the desktop scanning procedure. Therefore, a technique which includes scanning rather than impression material would be an improvement over existing industry practices.

Determination of an Edentulous Individual's Bite

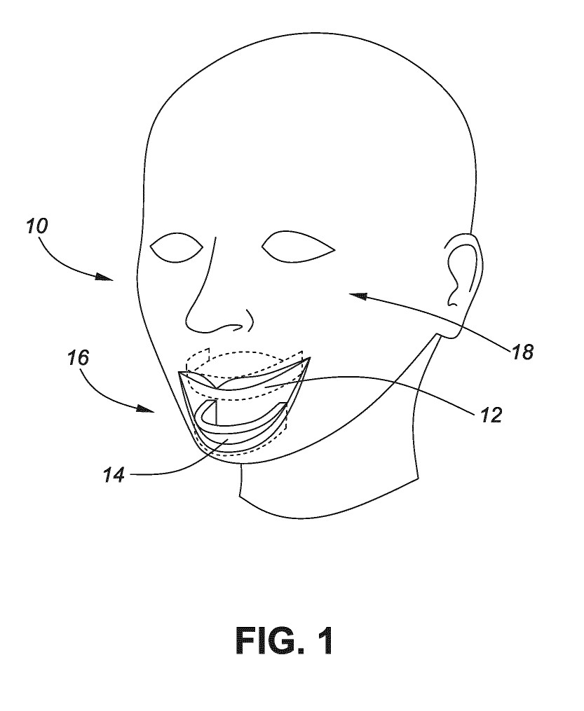

FIG. 1 is an edentulous individual 10 with an upper maxillary arch 12 and a lower mandibular arch 14 in their mouth 16. Neither the maxillary arch 12 nor the mandibular arch 14 has any dentition, although the methods and systems disclosed herein may have application in partially dentate individuals. External facial features 18 of the individual 10 are those features of the face, particularly around the mouth 16, which reflect changes in the individual's facial expressions (e.g. when the individual 10 smiles, grimaces, whistles, etc.) and may include the mouth, nose, eyes, or other external features.

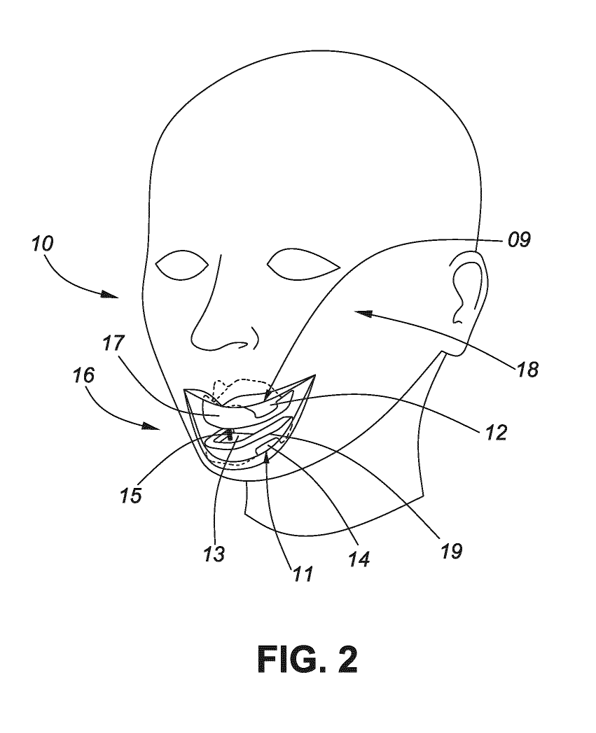

FIG. 2 shows the individual 10 with an upper maxillary tray component 17 and a lower mandibular tray component 19 in the mouth 16. The maxillary tray 17 receives the maxillary arch 12 and the mandibular tray 19 receives the mandibular arch 14. Together, the maxillary tray 17 and the mandibular tray 19 are a pair of trays. A maxillary aperture 09 is defined in the maxillary tray 17 to expose the maxillary arch 12, and a mandibular aperture 11 is defined in the mandibular tray 19 to expose the mandibular arch 14.

A maxillary bite establishment component 13 extends from the maxillary tray 17 and a mandibular bite establishment component 15 is located on the mandibular tray 19. In the trays 17, 19, the maxillary bite establishment component 13 is a pin, and the mandibular bite establishment component 15 is a recording plate, providing the functionality of a pin tracer. Other suitable maxillary bite establishment components 13 and the mandibular bite establishment components 15 may also be used (e.g. partial dentition, etc.). Together, the maxillary bite establishment component 13 and the mandibular bite establishment component 15 allow the individual 10, who is edentulous, to define a bite. The maxillary tray 17 and the mandibular tray 19 may be locked in one position to maintain the bite position when the trays 17, 19 are placed into and removed from the mouth 16.

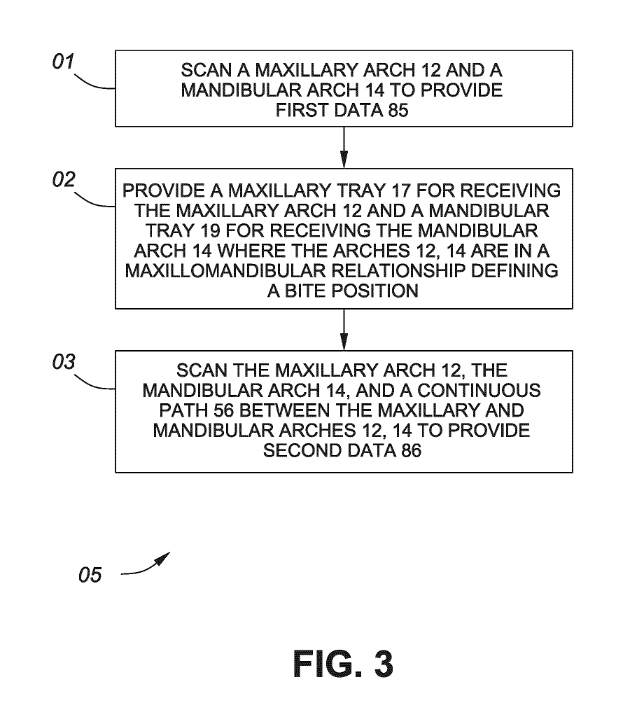

FIG. 3 is a flow chart of a scanning method 05 for scanning the individual 10 to model the maxillary and mandibular arches 12, 14.

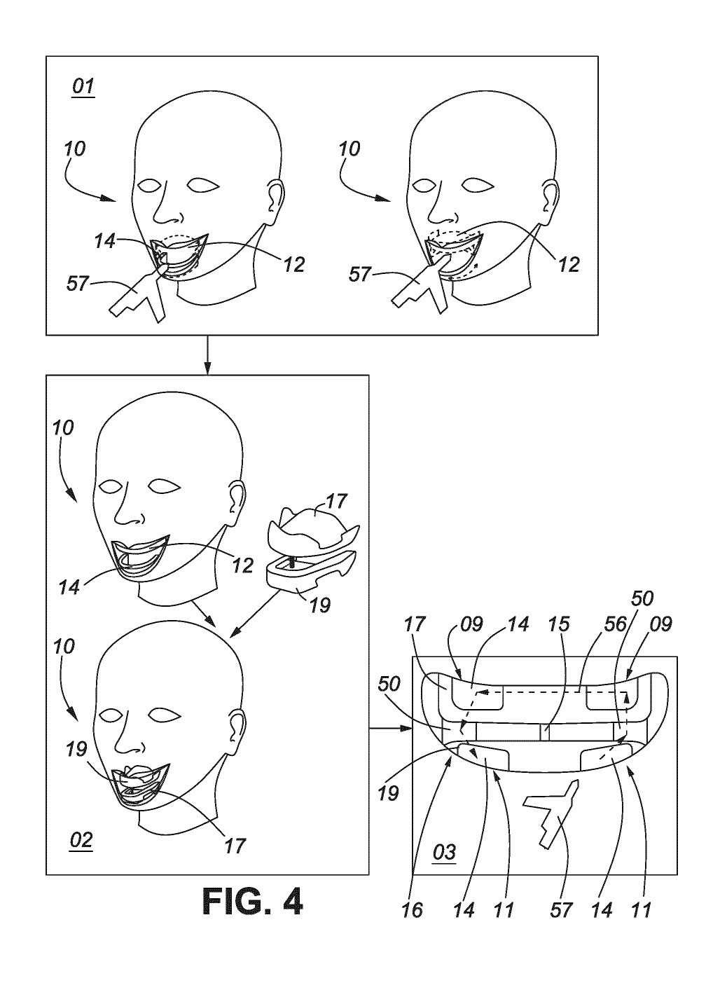

FIG. 4 is a schematic of the scanning method 05 being carried out on the individual 10. At portion 01 of the method 05, first data 85 is acquired by scanning the maxillary and mandibular arches 12, 14 with an intraoral scanner 57. The first data 85 facilitates preparing 3D models of the maxillary and mandibular arches 12, 14. The first data 85 includes sufficient coverage of the maxillary and mandibular arches 12, 14 to model the surfaces on which dentures or other appliances may rest (e.g. the first data 85 may include data of substantially the entirety of each of the maxillary and mandibular arches 12, 14, the entirety of one of the two arches 12, 14 but less of the other, etc.). In FIG. 4, the first data 85 is shown as being collected at portion 01 by an intraoral optical scanner 27. Other suitable scanners may also be used (e.g. an extraoral optical scanner, an extraoral optical scanner with cheek retractors, an ultrasonograph, etc.).

At portion 02 of the method 05, maxillary and mandibular trays 17, 19 are provided to the individual 10. When the maxillary and mandibular trays 17, 19 are placed in the individual 10's mouth, the individual 10 is in a maxillomandibular relationship defining a bite position. The maxillary and mandibular trays 17, 19 may be locked in the position defining the bite position so that the maxillary and mandibular trays 17, 19 maintain this position when removed from the mouth 16.

At portion 03 of the method 05, second data 86 is acquired by scanning the arch 12, the arch 14, and a continuous path 56 between the maxillary arch 12 and the mandibular arch 14. The second data 86 is acquired, while maxillary and mandibular trays 17, 19 are in the mouth 16 and the maxillomandibular relationship is at a bite position. The second data 86 includes empirical data of the maxillomandibular relationship at the bite position. Since the bite is defined by the maxillary and mandibular trays 17, 19, and the second data 86 is acquired at the bite position, portion 02 precedes portion 03. Portion 01 may be performed either before or after portions 02 and 03.

The continuous path 56 provides an unbroken path between the maxillary and mandibular arches 12, 14. The continuous path 56 may begin at the mandibular arch 14 (as shown by the origin of the continuous path 56 in FIG. 4) as viewed through the mandibular aperture 11. From the mandibular arch 14 at the mandibular aperture 11, the continuous path continues across material 50 (e.g. impression material, bite registration material, intraoral putty etc.) being used to connect the maxillary and mandibular trays 17, 19. From the material 50, the continuous path 56 reaches the maxillary arch 12 as viewed through the maxillary aperture 09. At this point, the continuous path 56 has crossed both of the maxillary and mandibular arches 12, 14 and the second data 86 may be prepared. However, the second data 86 may benefit from an increased amount of data along the continuous path. To provide a greater amount of the second data 86, the continuous path 56 follows across the maxillary tray 17 to another maxillary aperture 11, where another portion of the maxillary arch 14 is visible, and from there downwards across more of the material 50 to the mandibular tray 19, where the mandibular arch 14 can be viewed through another of the mandibular apertures 11.

The continuous path 56 includes two points of contact with each of the maxillary and mandibular arches 12, 14. However, a continuous path may follow any route which includes each of the maxillary and mandibular arches 12, 14. The material 50 is provided to allow the continuous path 56 to include each of the maxillary and mandibular arches 12, 14 without losing a frame of reference in the space between the maxillary and mandibular trays 17, 19. The depth of field of current scanners is often typically too shallow to acquire reliable second data 86 across the gap between the maxillary and mandibular trays 17, 19, and as such, without the material 50, the maxillary and mandibular trays 17, 19 fail to provide a frame of reference along the portion of the continuous path 56 between the maxillary and mandibular trays 17, 19. Future improvements in depth of field for optical scanners are expected to facilitate acquisition of the second data 86 along a continuous path which does not include the material 50 or any other features directed to providing a frame of reference within a shallow depth of field (e.g. the bridge 148 and other examples of bridges shown below, etc.). However, with most current optical scanners (intraoral or extraoral), the material 50 or other features which bridge the maxillary and mandibular trays 17, 19 facilitate acquisition of the second data 86 along the continuous path 56.

Indelible ink or other temporary marking techniques may be applied to the maxillary and mandibular arches 12, 14 to make visible markings (not shown) on the maxillary and mandibular arches 12, 14, which can be used as an aid in meshing and aligning the first data 85 with the second data 86 when preparing the first model 21. The temporary markings would be present in both the first data 85 with the second data 86. With the temporary markings, the size of the continuous path 56 which provides a selected amount or quality of the second data 86 may be reduced.

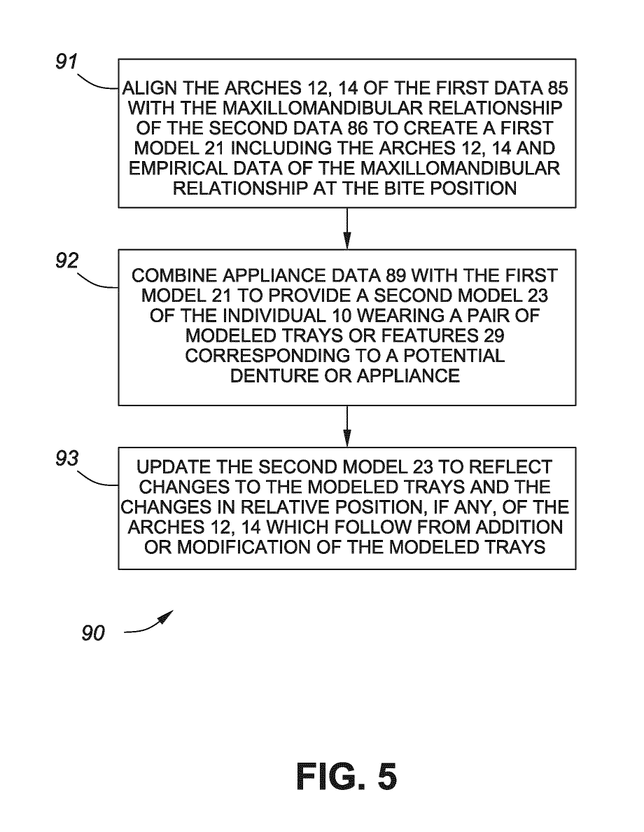

FIG. 5 is a flow chart of a processing method 90 for assembling the first data 85 and the second data 86 into a first model 21 of the individual 10 for designing or optimizing dentures or other dental appliances.

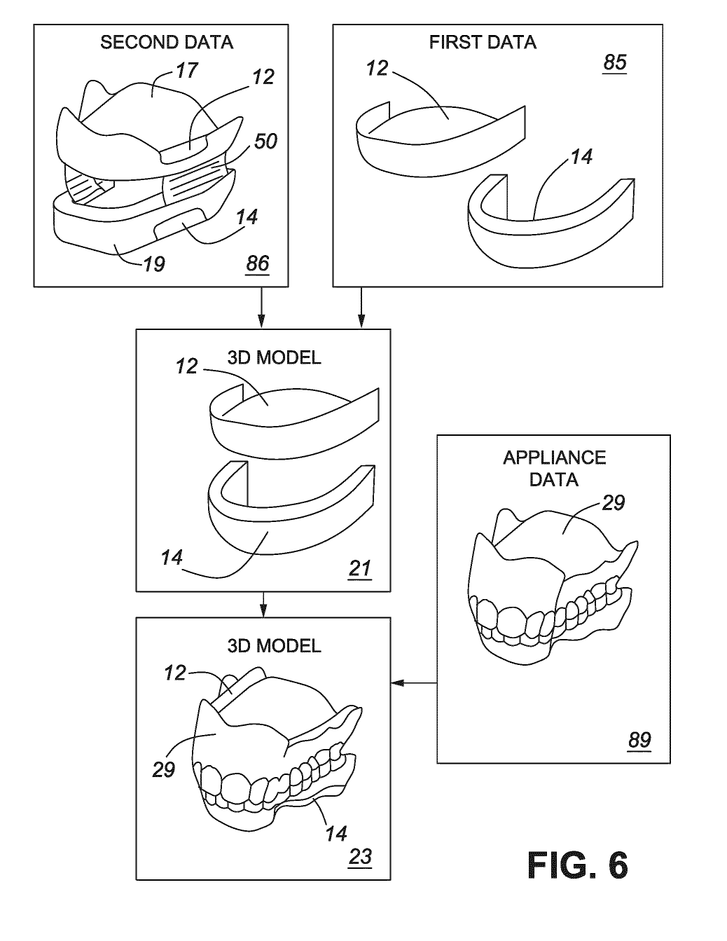

FIG. 6 is a schematic of the data used in the method 90. At portion 91 of the method 90, the first data 85 and the second data 86 are combined to prepare the first model 21. The first model 21 includes the models of the maxillary and mandibular arches 12, 14 based on the first data 85, and includes empirical data of the maxillomandibular relationship at the bite position based on the second data 86. As a result, the maxillomandibular relationship in the first model 21 reflects the actual maxillomandibular relationship of the individual 10 in the bite position defined by the maxillary and mandibular trays 17, 19.

At portion 92 of the method 90, appliance data 89 of a denture 29 or other dental appliance or feature may be added to the first model 21 to provide a second model 23. The appliance data 89 is shown as facilitating modelling the denture 29. The denture 29 may be the individual's previous dentures, in which case the appliance data 89 may be obtained by scanning the individual's previous dentures. Alternatively, the denture 29 may be selected from a library, in which case the appliance data 89 may be sourced from the library. The denture 29 may also be manipulated or changed through the modelling software (e.g. to choose specific features of dentition which will maintain the bite from the second data 86, to change to the denture 29 resulting in changes to the individual 10's bite, etc.).

At portion 93 of the method 90, the maxillomandibular relationship defined by the denture 29 is updated in response to introduction of the dentures 29 or changes to the dentures 29 as described in relation to portion 92.

Where the denture 29 is the individual 10's existing dentures, the appliance data 89 may be acquired by scanning the individual 10's existing dentures. In some cases, a splint material may be applied to a maxillary denture, a mandibular denture, or both dentures, to restore a more appropriate bite position prior to proceeding with the method 05. For example, wax, repair acrylic, or bite registration material may be placed on teeth present on the maxillary and mandibular trays 17, 19 to restore the vertical of the individual 10's bite. As denture teeth wear out, the individual 10's bite may migrate into inappropriate positions for optimal function, which may be mitigated with the splint material. In cases of excessive bone loss or tooth wear, the mandible can progress forward protrusively so that the bottom teeth protrude well beyond the top teeth. If the previous denture were used for design purposes in this case, a splint may be used to correct the position of the denture for design of a new denture.

In some embodiments, a temporary material can be applied to top, bottom, or both dentures, to restore a more appropriate lip support, prior to proceeding with the method 05. For example, wax may be added to the outside surfaces of the dentures to provide custom facial support, and the resulting dentures with temporary material be scanned and incorporated into a new prosthetic.

Older dentures often do not load the gums appropriately, as the shape of the gums, on which the dentures rest, is constantly shrinking and changing. Additionally, as denture teeth wear out, an individual's bite can migrate into inappropriate positions for optimal function. U.S. publication no. 2013/0209962 details a method in which denture fit shortcomings are addressed by taking impressions inside the denture tissue fitting sides, and using a bite registration material to record a bite, then scanning the resultant denture, impression material and bite registration. The method 05 does not rely on registration material to acquire the first and second data 85, 86. Where using existing dentures is not appropriate, a pin tracer can be used to record a bite.

Denture Replica

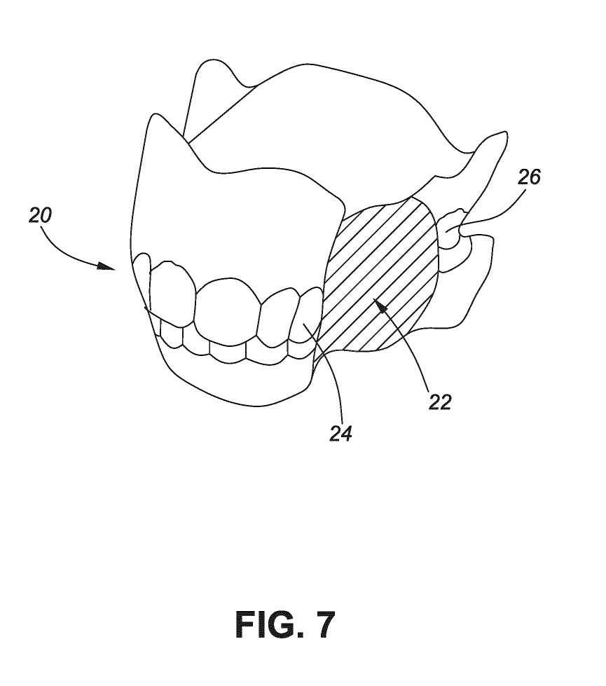

FIG. 7 shows a replica 20 of the individual 10's dentures.

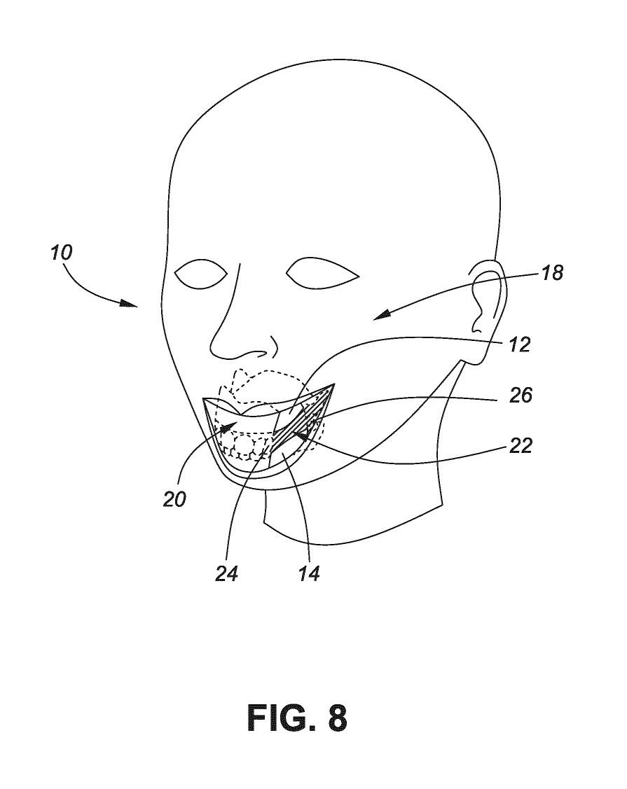

FIG. 8 shows the replica 20 in the mouth 16 of the individual 10. Unlike the individual's dentures, the replica 20 includes an aperture 22 on each buccal facial side of replica 20 to expose a portion of the maxillary and mandibular arches 12, 14. When placed in the mouth 16, the replica 20 provides a continuous path between the maxillary arch 12 and the mandibular arch 14 to register a maxillomandibular relationship. Anterior dentition 24 and posterior dentition 26 adjacent to the aperture 22 provide a frame of reference within the depth of field for commonly used scanners which cross between the maxillary and mandibular arches 12, 14.

The replica 20 may include other apertures similar to the aperture 22 at several locations to facilitate accurate scanning (not shown). Adding more apertures, or increasing the size of the apertures may increase the amount of the second data 86 acquired by exposing more of the maxillary arch 12, the mandibular arch 14, or both, to scanning. The greater the resolution and depth of field of the scanner being used, the smaller the aperture 22 may be. The aperture 22 may expose, for example, about a square centimeter on each of the maxillary and mandibular arches 12, 14. However, if too many apertures of too large a size are placed at the wrong portion of the replica 20, the individual 10 may not be able to effectively bite down on the replica 20 without the replica 20 slipping out from between the maxillary and mandibular arches 12, 14 due to uneven loading.

When selecting the size, number, and location of apertures on a replica, the competing considerations of sufficient exposure of the maxillary and mandibular arches 12, 14 along the continuous path must be balanced with the stability of the replica 20 in the mouth 16 when the individual 10 bites down on the replica 20. To facilitate a stable bite on the replica 20, the aperture 22 is positioned between the maxillary tuberosities and maxillary canine eminences on the maxillary arch. Similarly, on the mandibular arch, the aperture 22 is positioned between the mandibular canine eminences and the mandibular retromolar pads.

Operation of scanners is constrained by applicable tolerances of the field of view depth. For example, some current intraoral optical scanners cannot record a depth of more than about 4 mm, with about 16 mm being a deep tolerance with current intraoral optical scanners. For example, some current extraoral optical scanners cannot record a depth of more than about 1,500 mm accurately.

The replica 20 may be prepared by any appropriate method (e.g. built using previous casting methods, 3-D printed, etc.). Scanning the individual 10's dentures to provide the appliance data 29 allows rapid prototyping of the replica 20 and modelling of the individual 10's dentures at portion 92 for modification at portion 92. In addition, the modeled denture trays may be removed from the second model 23 to analyze, diagnose and/or design new prosthesis on the model 21 at the bite position.

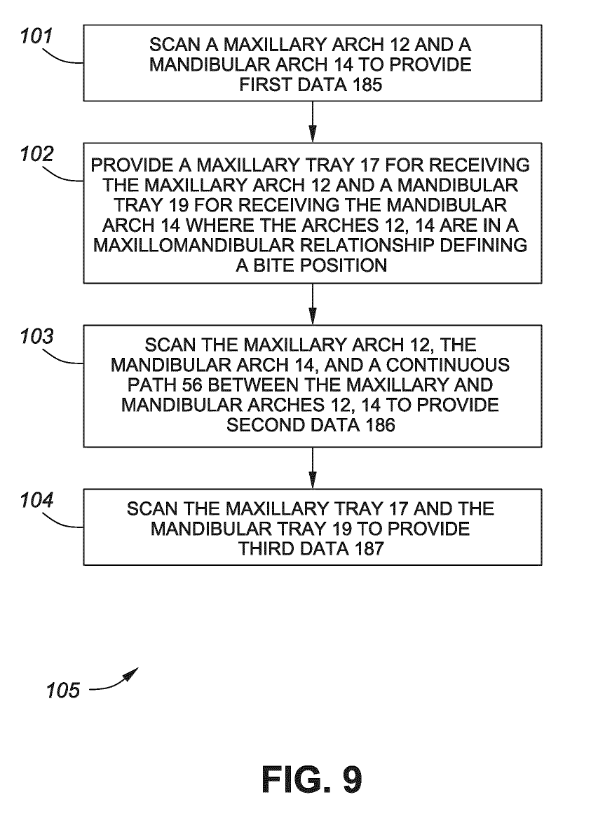

FIG. 9 shows a method 105 which includes scanning the maxillary tray 17 and the mandibular tray 19 to provide third data 187 at portion 104 of the method 105. An extraoral scanner 59 is used to scan the maxillary tray 17 and the mandibular tray 19.

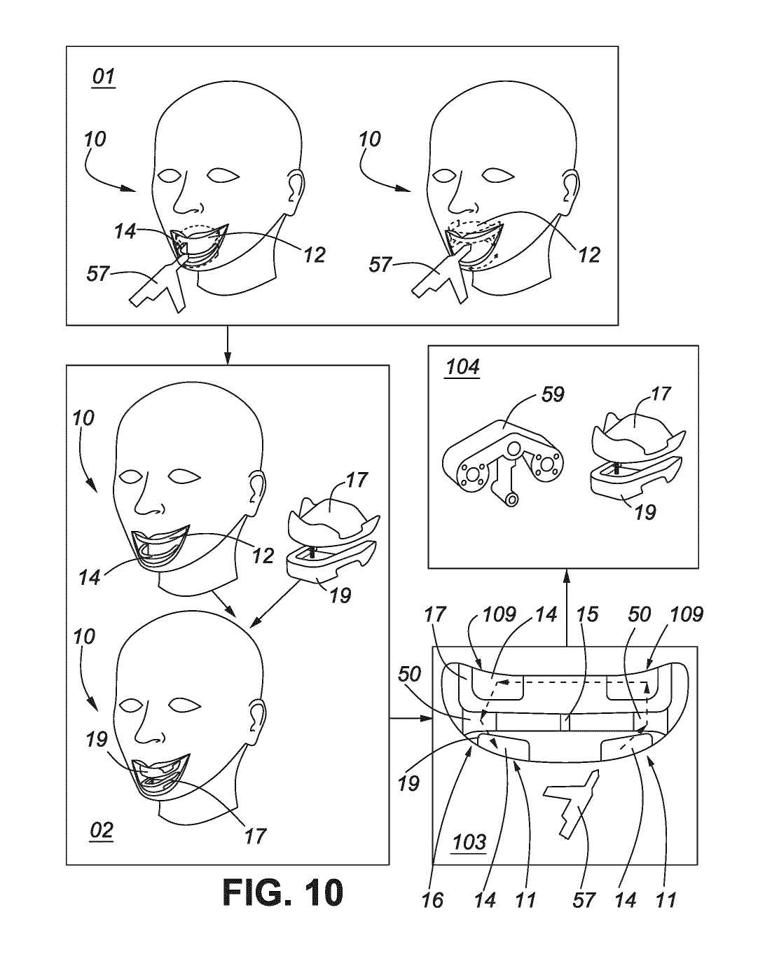

FIG. 10 is a schematic of acquisition of data by the method 105. The third data 187 may include data of all sides of each of the trays 17, 19 to facilitate preparing an accurate model of the trays 17, 19 for a second model 125 (see below). Alternatively, the third data 187 may include data of the individual's dentures (not shown) to prepare the replica 20, similarly to the appliance data 89 being based on data from the individual's dentures. In this case, the second data 186 would be acquired while the replica 20 is in the individual's mouth (not shown; in FIGS. 9 and 10, the maxillary and mandibular trays 17, 19 were scanned for the third data 187, so the second data 186 is based on a bite established with the maxillary and mandibular trays 17, 19, which may also be used to prepare the replica 20). Since the bite is defined by the maxillary and mandibular trays 17, 19, and the second data 186 is acquired at the bite position, portion 102 precedes portion 103. Portion 101 and portion 104 may each be performed either before or after portions 102 and 103, or before or after each other.

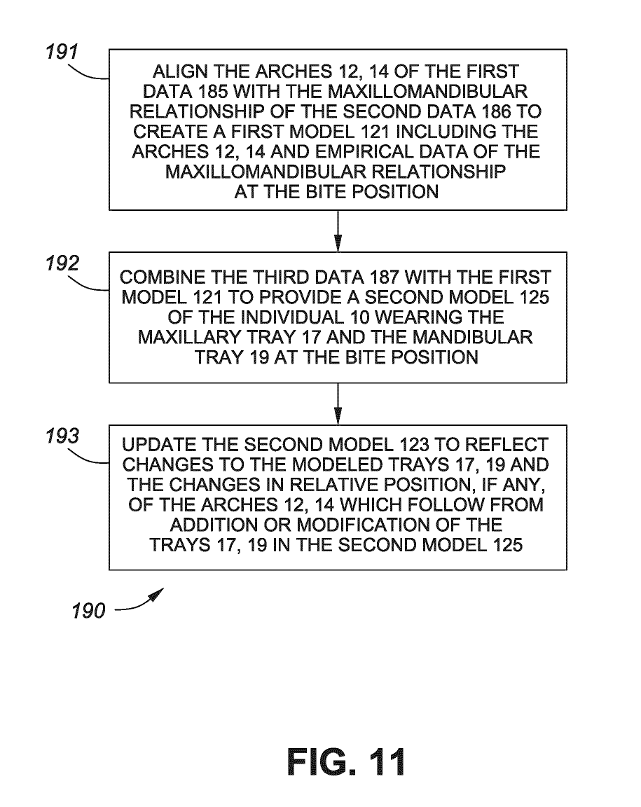

FIG. 11 shows a method 190 of preparing the first model 121 and a second model 125.

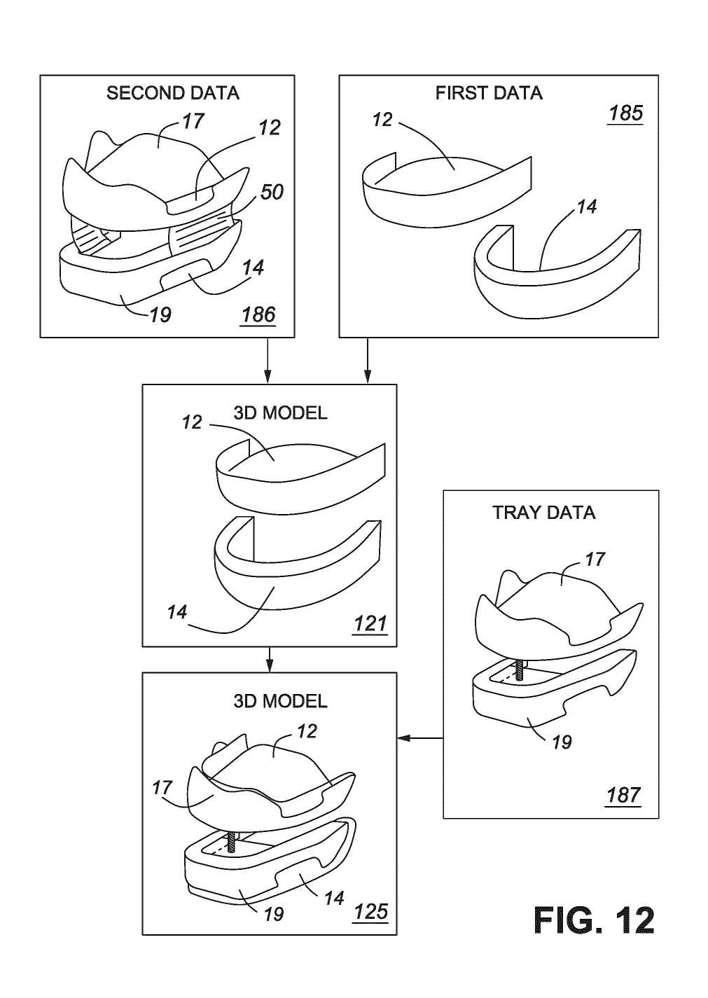

FIG. 12 is a schematic of the data used in the method 190. The third data 187 is combined with the first model 121 at step 194 to provide a second model 125 of the individual at the bite position and wearing the maxillary and mandibular trays 17, 19. The maxillary and mandibular trays 17, 19 may be a useful starting point for designing a new appliance at portions 194 and 193. The maxillary and mandibular trays 17, 19 may be removed from the second model 125 to analyze, diagnose and/or design new prosthesis on the model 121 at the bite position.

The replica 20 or the dentures of the individual 10 may be used as a starting point for the third data 187 or the appliance data 89 in cases where the bite of the individual 10 is unlikely to change. This may be the case where individual 10's dentures are being updated cosmetically. Where the bite of the individual 10 is likely to change significantly from the bite provided by the existing dentures, a pin tracer may be used to establish a new bite.

Pin Tracer

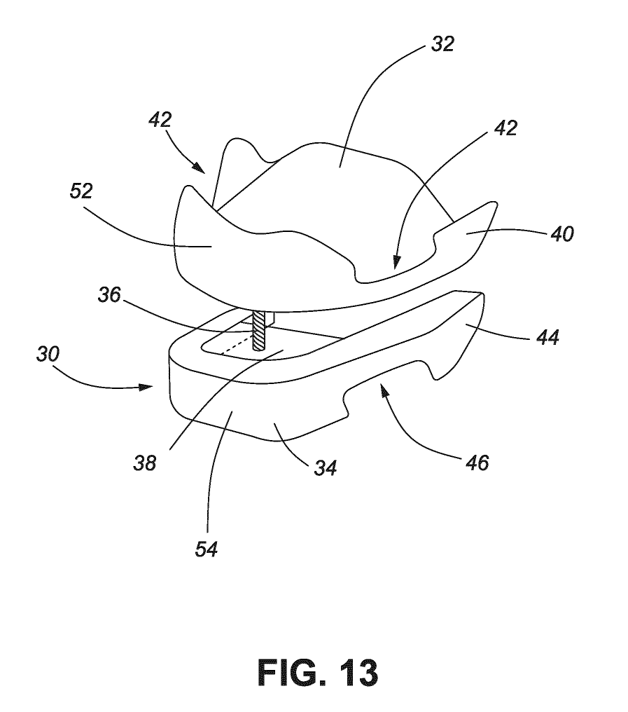

FIG. 13 is a pin tracer 30 for determining the centric occlusion maxillomandibular relationship bite position in some embodiments of the method 05. A maxillary component 32 is shaped to receive a maxillary arch and a mandibular component 34 is shaped to receive a mandibular arch. A pin 36 extends from the maxillary component 32 and a recording plate 38 is secured to the mandibular component 34 (alternatively, a pin could be placed on a mandibular component and a recording plate on a maxillary component). The pin 36 marks the recording plate 38 when the maxillary component 32 is moved relative to the mandibular component 34. Marks made by the pin 36 on the recording plate 38 allow identification of the bite position. The maxillary component 32 and the mandibular component 34 may be locked in place relative to one another at the bite position (or any other position). The pin tracer 30 would then be placed in an individual's mouth and the individual's arches and pin tracer 30 scanned together (this would apply for example to portion 103 of the scanning method 105).

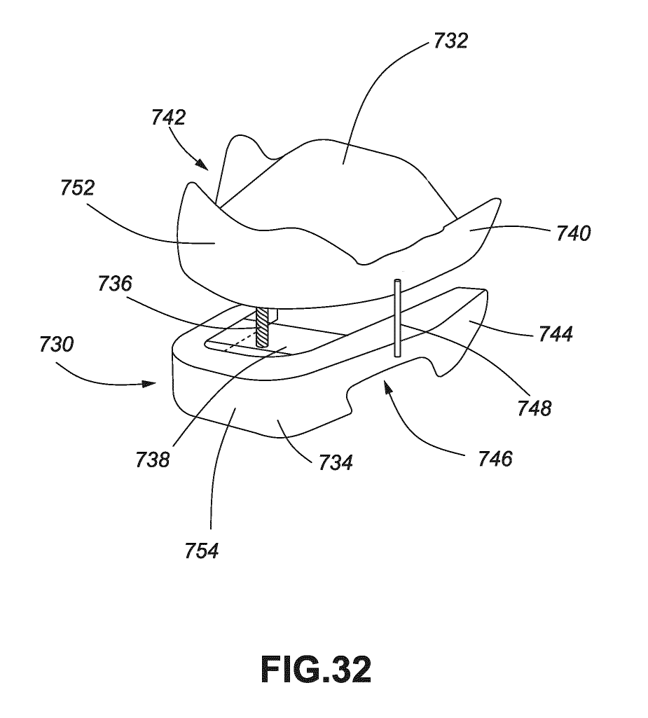

A maxillary buccal wall 40 of the maxillary component 32 includes a maxillary aperture 42. A mandibular buccal wall 44 of the mandibular component 34 includes a mandibular aperture 46. Apertures similar to maxillary and mandibular apertures 42, 46 may be included on a maxillary labial wall 52 and a mandibular labial wall 54 in addition to or instead of the buccal walls 40, 44. Other potential locations for apertures are described below with reference FIGS. 32 to 35.

The maxillary and mandibular apertures 42 and 46 provide a clear line of sight to the arches, exposing a portion of both the maxillary and mandibular arches 12, 14. Use of an intraoral scanner to record a maxillomandibular relationship is facilitated where a portion of the maxillary arch 12 and of the mandibular arch 14 can be captured in a single continuous path (e.g. the continuous path 56, etc.). Depending on the type of scanner used, it may be possible to capture both the maxillary and mandibular arches 12, 14 in a single field of view. Previous pin tracers and dentures cover nearly all the maxillary and mandibular arches 12, 14 and do not provide a useful aperture for scanning the maxillary and mandibular arches 12, 14 at the same time as scanning the pin tracer, and therefore did not facilitate modelling based on empirical scanning data of the bite position. In contrast, the methods and systems disclosed herein facilitate modelling based on empirical scanning data of arches at the bite position.

To facilitate a stable bite on the pin tracer 30, the maxillary apertures 42 are positioned between the maxillary tuberosities and maxillary canine eminences on the maxillary arch. Similarly, on the mandibular arch 14, the mandibular apertures 46 are positioned between the mandibular canine eminences and the mandibular retromolar pads.

Most dentures or pin tracer devices have a gap between the maxillary and mandibular arch components, allowing contact only between the pin and recording plate (e.g. see U.S. publication no. 2013/0280672 or U.S. publication no. 2012/0322031) to prevent contact between portions of the maxillary and mandibular arch components other than the pin and recording plate during tracing. Such gaps are often present at a posterior portion of the pin tracer. These gaps prevent most intraoral scanners (which have a comparatively shallow depth of view) from recording the maxillary and mandibular components of the pin tracer in the same field of view, complicating record of a maxillomandibular relationship. The pin tracer 30 lacks structures which provide a continuous frame of reference for a continuous scanning path (e.g. the continuous path 56, etc.). As shown in FIGS. 4, 10, 25, and 31, the material 50 may be used to provide a frame of reference for the portion of the continuous path between the maxillary component 32 and the mandibular component 34. Alternatively, structures may be included with a pin tracer to provide the frame of reference.

Bridge

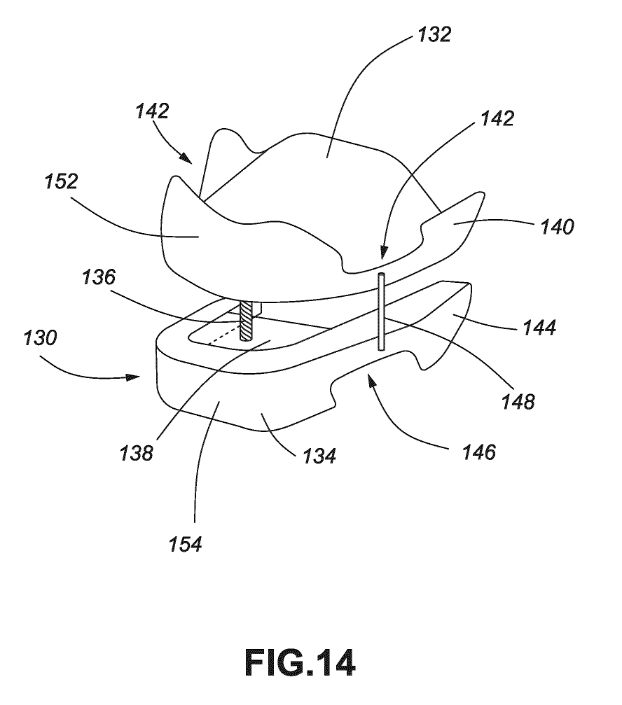

FIG. 14 shows a pin tracer 130 having a bridge 148 (e.g. a small length of metal or other rigid material, etc.) connecting the maxillary and mandibular components 132, 134 of the pin tracer 130. The bridge 148 provides a frame reference for the continuous scanning path between the maxillary and mandibular arches 12, 14, provided by the apertures 142, 146.

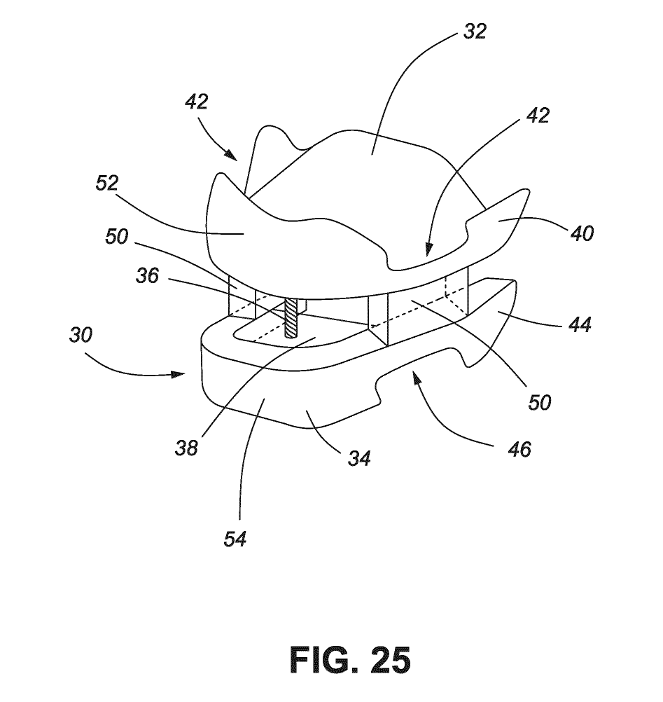

As described above, some scanners have limitations with regards to depth scanning tolerances that are shallower than the distance between the left and right portions of the maxillary buccal walls 40 and of the mandibular buccal walls 44 (e.g. scanning cannot be completed further than about 4 mm from the scanner in some commercial intraoral scanners). To address this, the space between the maxillary and mandibular portions of the pin tracer device is bridged with a mechanical device such as the bridge 148 or filled with a material (e.g. the material 50 in FIGS. 4 and 25). Any gaps or voids between the components 132, 134 deeper than the tolerance of the scanner are bridged or filled, providing the continuous path between the exposed maxillary and mandibular arches (specifically the maxillary and mandibular gums). The bridge 148 allows a scanner to make a pass between the maxillary and mandibular arches along a continuous path with a consistent frame of reference to register a maxillomandibular relationship. As above, apertures can be included at multiple locations, and a bridge can be included at each location to increase accuracy of data acquisition. The bridge 148 provides a consistent frame of reference along the continuous path between the apertures 142, 146 which is easily scanned within the depth of field of most optical scanners, and which can be contacted by an ultrasound scanner or other touch-based scanner.

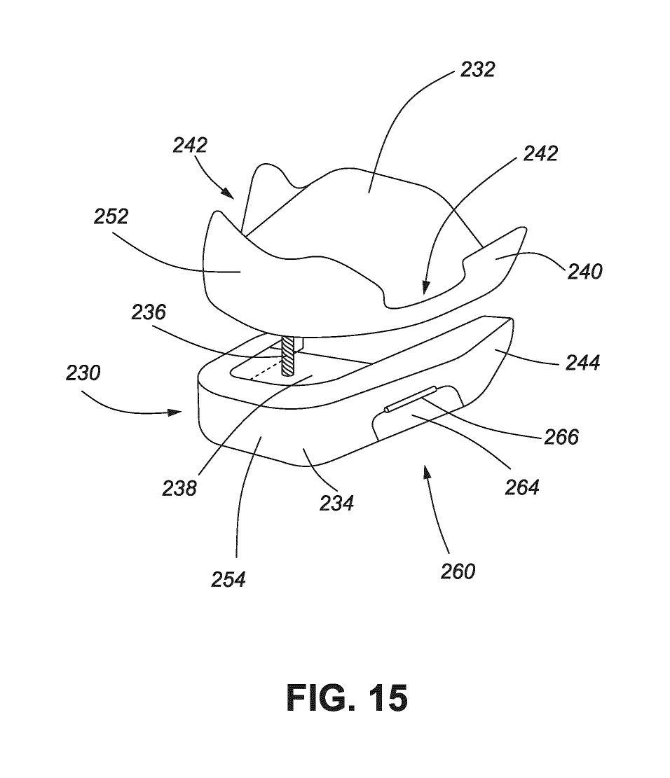

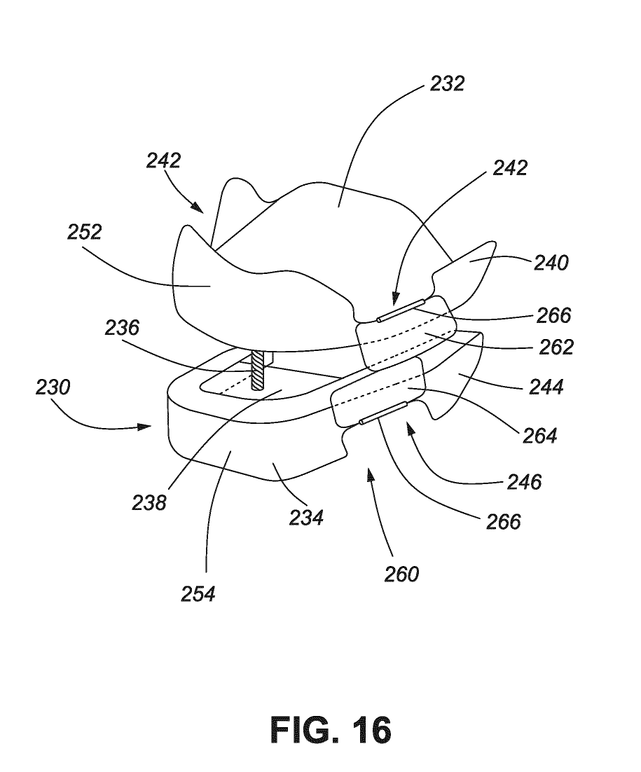

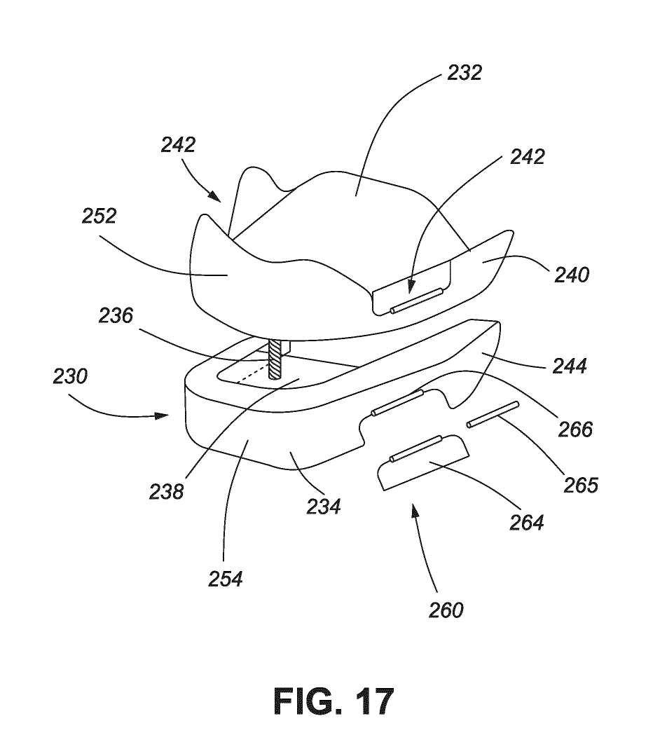

FIGS. 15 to 17 show a pin tracer 230 with a hinged bridge 260 including a maxillary hinged bridge component 262 and a mandibular hinged bridge component 264. In the closed position, such as the bridge component 264 in FIG. 15, the bridge components do not cross the gap between the maxillary and mandibular components 232, 234. When the bridge components 262, 264 are each in an open bridging position (FIG. 16), the bridge components 262, 264 contact each other, providing a bridge between the maxillary and mandibular components 232, 234 and a consistent frame of reference for the continuous path. Alternatively, a single bridge component could be applied which would bridge the maxillary and mandibular components 232, 234, and could be located on either of the maxillary or mandibular components 232, 234 (not shown). The hinged bridge components 262, 264 are connected to the maxillary and mandibular components 232, 234 by hinges 266. The hinges 266 may be removable (FIG. 17).

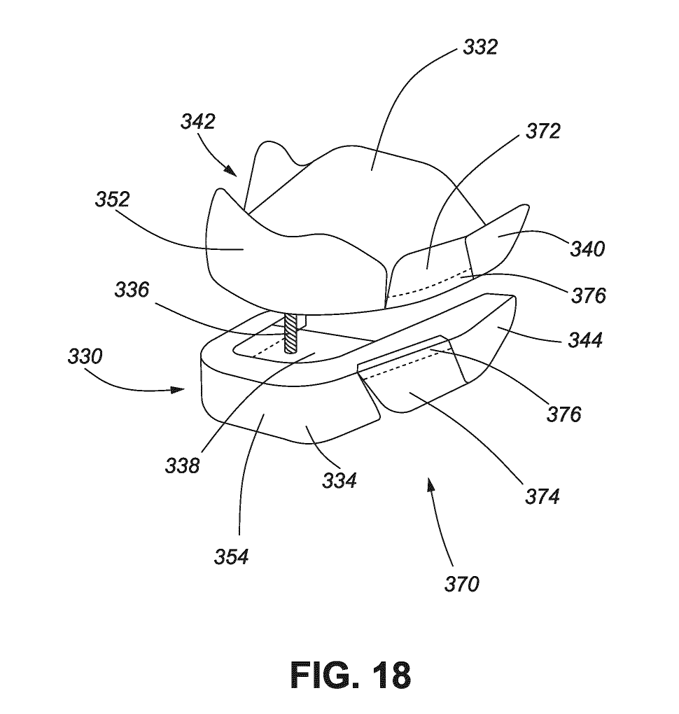

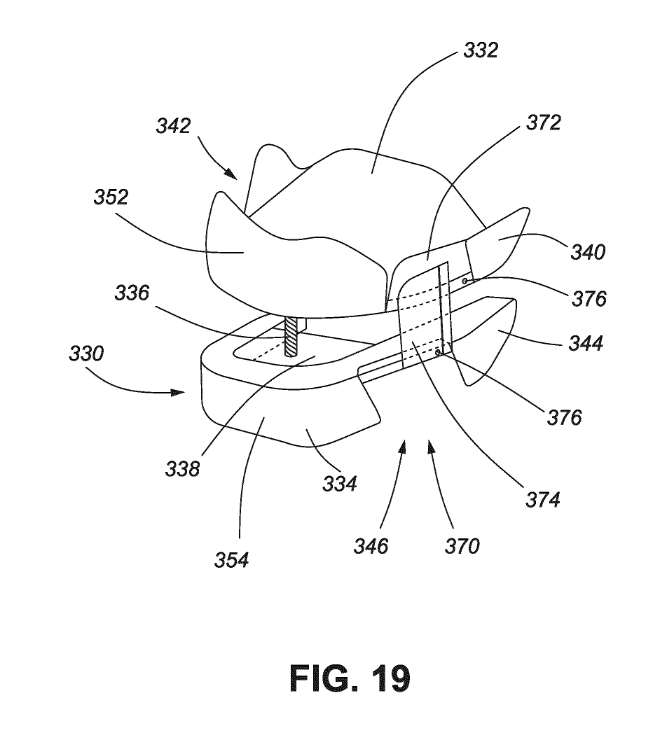

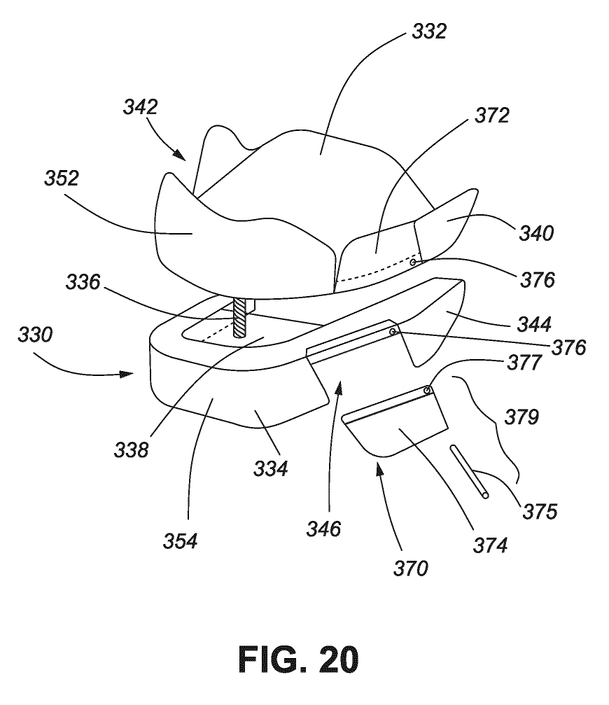

FIGS. 18 to 20 show a pin tracer 330 with a pivoting bridge 370 including a maxillary pivoting bridge component 372 and a mandibular pivoting bridge component 374. When one of the bridge components 372, 374 is in an open bridging position (FIG. 19), the bridge components 372, 374 contact each other, providing a consistent frame of reference for the continuous path between the maxillary and mandibular components 332, 334. The hinged bridge components 372, 374 are connected to the maxillary and mandibular components 332, 334 by a pivot 376.

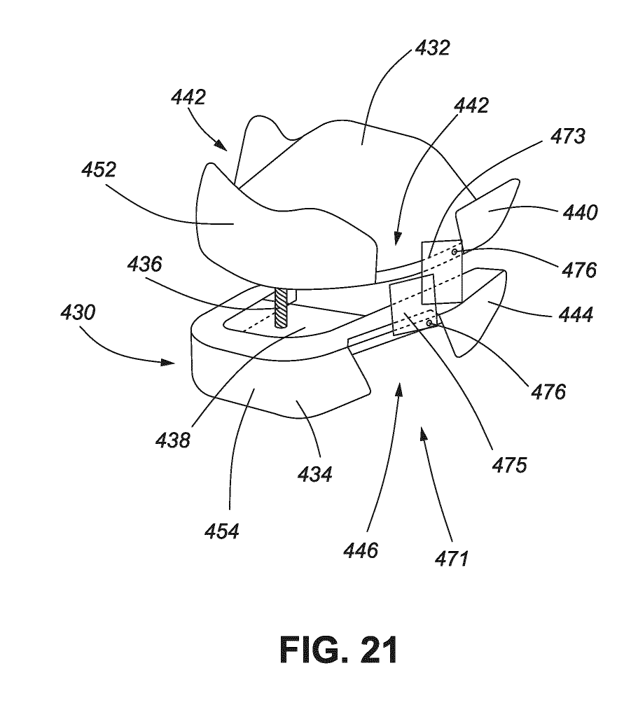

FIG. 21 shows a pin tracer 430 with a pivoting bridge 471 including bridge component 473, 475 which are smaller than the bridge components 372, 374. Both bridge component 473, 475 are in the open position (as shown) in order to provide a connection between the maxillary and mandibular components 432, 434.

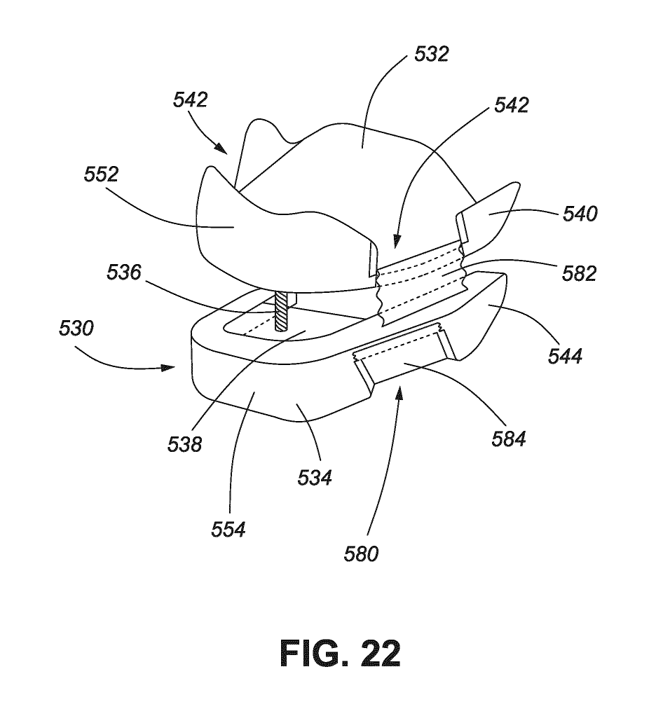

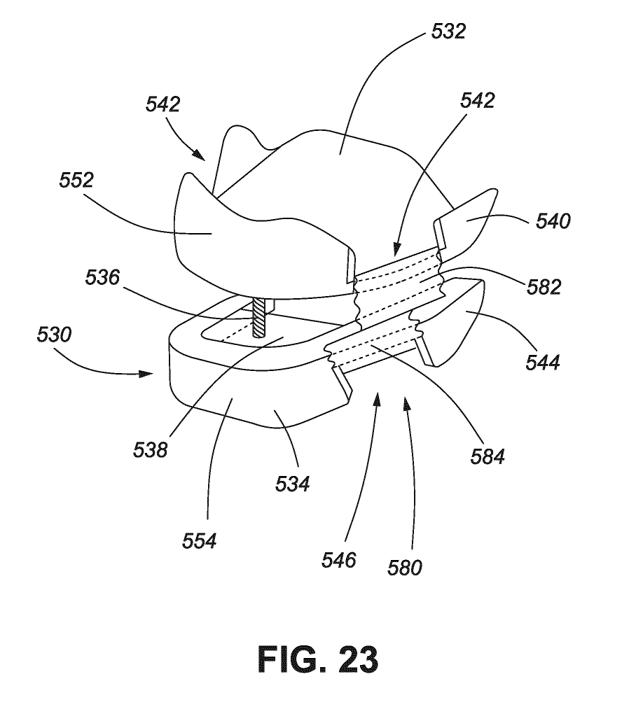

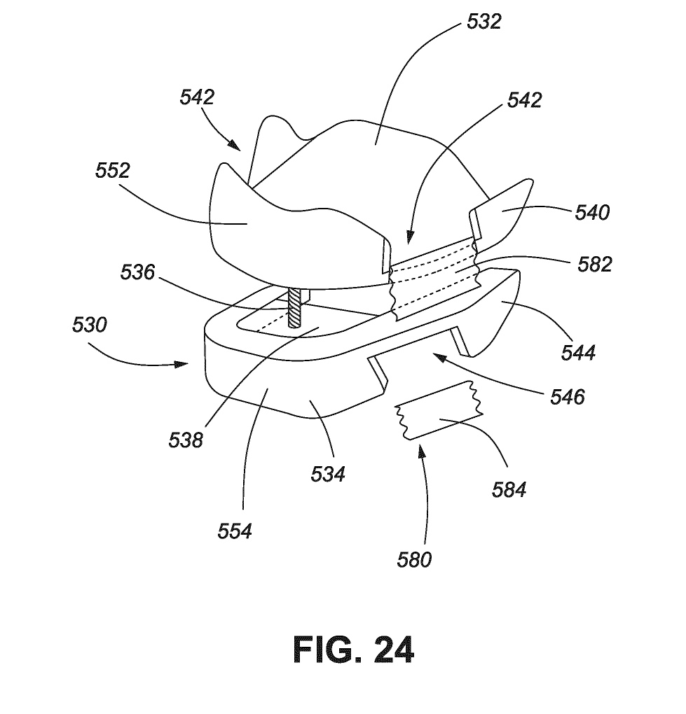

FIGS. 22 to 24 show a pin tracer 530 with a sliding bridge 580 including a maxillary sliding bridge component 582 and a mandibular sliding bridge component 584. When each of the bridge components 582, 584 is in an open bridging position (FIG. 23), the bridge components 582, 584 contact each other, providing a connection between the maxillary and mandibular components 532, 534. The sliding bridge components 582, 584 are slidably connected to the maxillary and mandibular components 532, 534.

The examples of bridge components shown herein each rest over the apertures 242, 246, 342, 346, and 542, 546, in the closed position (FIGS. 15, 18, 22). This facilitates scanning by locating the bridge components close to the apertures. However, the bridge components may be located apart from the apertures and need not cover the apertures when in the closed position.

The examples of bridge components may be used with the replica 20 if the dentition 24, 26 used in a given replica 20 does not bridge the maxillary and mandibular portions of the replica 20. Otherwise, the dentition 24, 26 could provide a bridge between the maxillary and mandibular portions of the replica 20.

All examples of pin tracers shown herein may include securing and locking features to secure and lock the maxillary and mandibular components 32, 34 in a given maxillomandibular relationship.

Beyond the examples shown, the bridge components could further include ratcheting features, piston and cylinder assemblies, or others.

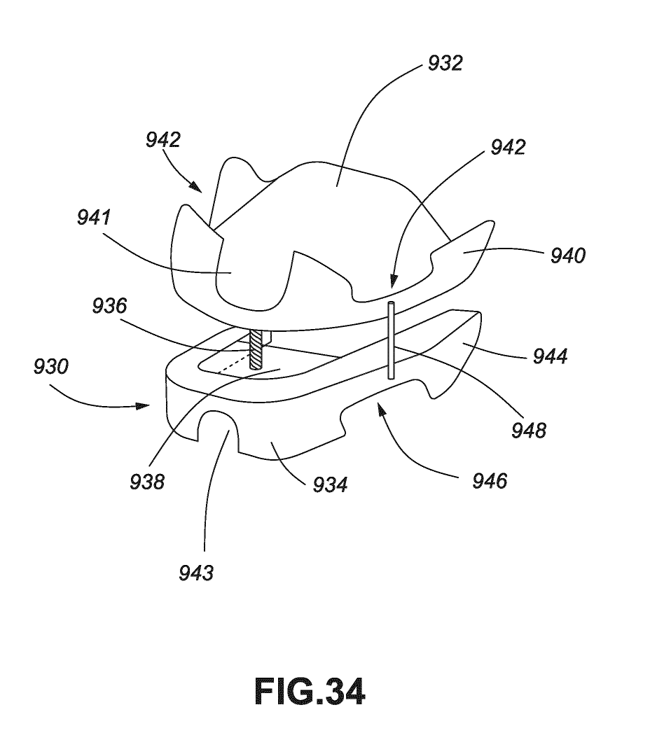

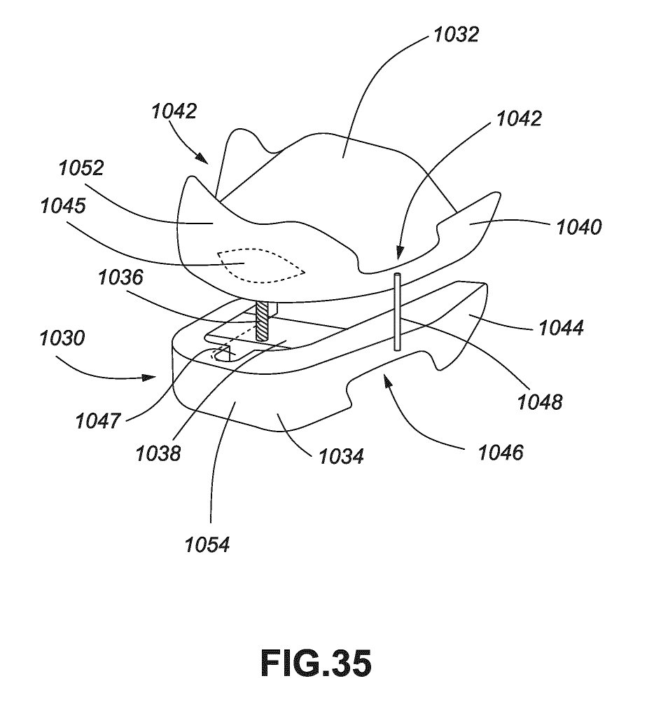

FIG. 25 shows material 50 (e.g. impression material, bite registration material, intraoral putty etc.) being used to connect the maxillary and mandibular components 32, 34 of the pin tracer 30. The bridge 148 or the material 50 are placed sufficiently close to the buccal walls 40, 44 to provide the continuous path at least within the depth of field of commonly used scanners. Where apertures similar to the apertures 42, 46 are placed on a maxillary labial wall 52 and a mandibular labial wall 54 in addition to or instead of the buccal walls 40, 44, the bridge 148 or the material 50 may be placed sufficiently close to the labial walls 52, 54 to provide the continuous path within the depth of field of commonly used scanners (see FIGS. 34 to 35).

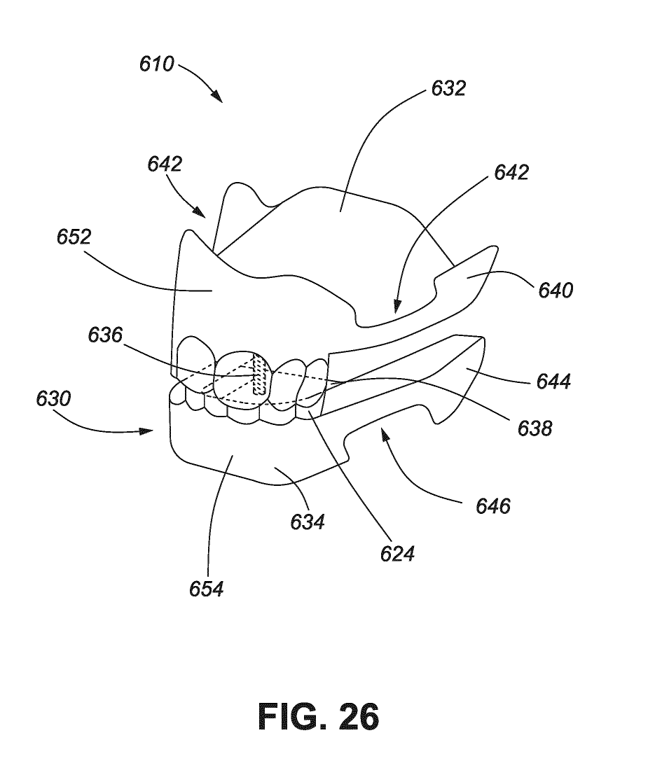

FIG. 26 is a custom pin tracer 630. In addition to the features of the pin tracer 30, the custom pin tracer includes anterior dentition 624. Anterior dentition 624 may be used to direct a maxillomandibular relationship of centric occlusion or help the individual 10 choose an appropriate cosmetic effect for the dentition 624. The custom pin tracer 630 shows the front six teeth. However, other variations of the anterior dentition 624 or of posterior dentition may also be included in the custom pin tracer 630 (e.g. maxillary teeth only, molars, etc.). The anterior dentition 624 provides a frame of reference for a continuous path between the maxillary apertures. The custom pin tracer 630 may include any of the bridges and bridge components shown in FIGS. 15 to 24, and material 50 may be used with the custom pin tracer 630 as in FIG. 25.

In some embodiments, the custom pin tracer 630 can be fabricated, either traditionally or by use of rapid prototyping techniques (3-D printing). The custom pin tracer 630 may, for example, incorporate some or all of the following features: (a) custom fit by using intraoral scan models to fabricate an ideal tissue fitting surface, (b) accommodating portions of the individual's existing dentures, (c) accommodating natural teeth, implants, or other restorations, (d) providing hypothetical tooth arrangements. These are features which would likely also be included in the replica 20.

The replica 20 may be used when the bite is unlikely to change as a result of modelling or treatment. Where a new bite is to be defined, the pin tracer 30 or one of its variants may be used. Where a new bite is to be defined and the individual 10 chooses to keep a consistence dental appearance, the customer pin tracer device 730 facilitates determination of a centric occlusion maxillomandibular relationship and provides relevant cosmetic landmarks.

External Scanning for Facial Information

The second model 23 includes the appliance data 89 of the individual 10's dentures or other appliance, or of a denture or appliance from a library. The second model 123 includes the third data 187 of the individual 10's dentures or of the maxillary and mandibular trays 17, 19. Each of these second models 23, 123, can be viewed without data of the external features 18. However, in some cases, data of the external features 18 may provide additional facial information for modelling, diagnosis and design. By recording common facial expressions (e.g. mouth closed at rest, mouth open at rest, high smile, etc.), this can provide esthetic information which can be recorded and used to assist visualization of proposed designs of restorations or prostheses. Visualization could be accomplished purely digitally on a model or using augmented reality to digitally visualize the proposed designs directly on the individual in real-time.

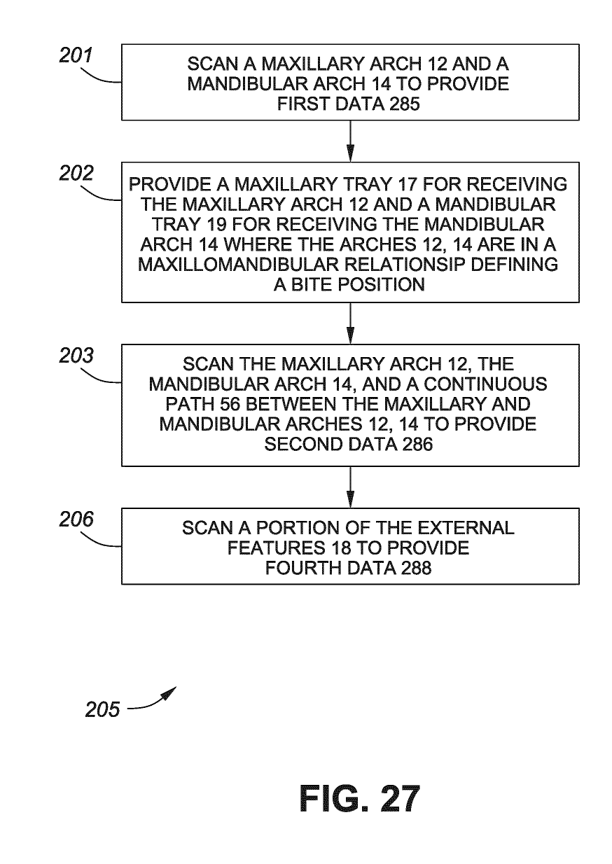

FIG. 27 shows a method 205 which includes scanning the external features 18 to provide the fourth data 288 at portion 206. The fourth data is acquired by scanning the external features 18 with the extraoral scanner 59.

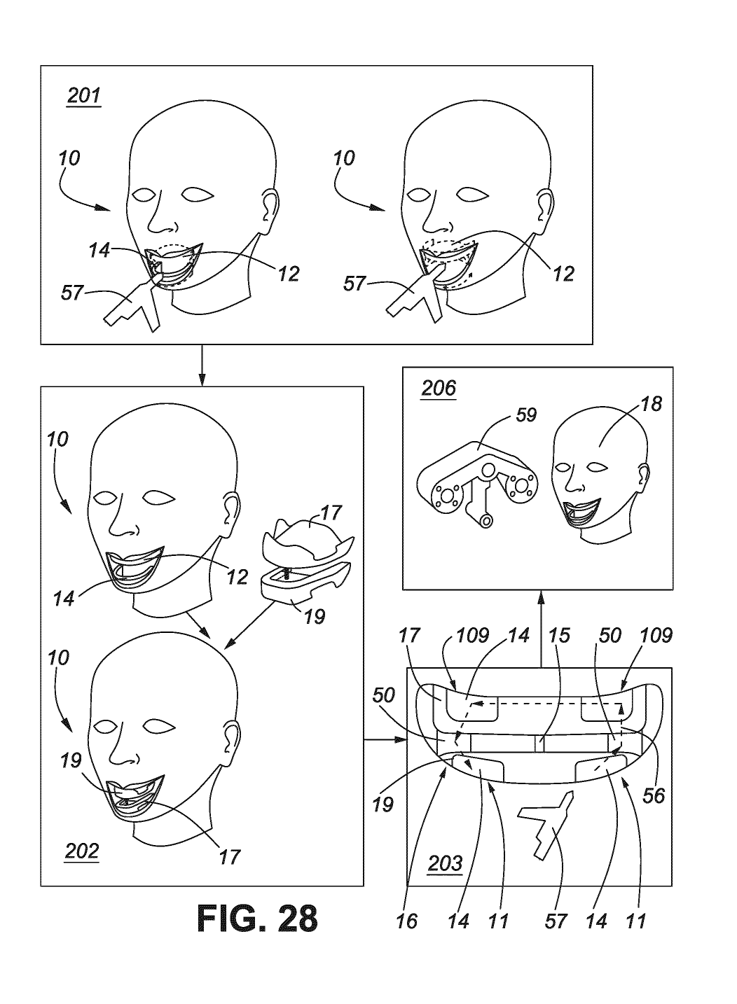

FIG. 28 is a schematic of acquisition of data by the method 205. The fourth data 288 is acquired by extraorally scanning the external features 18 of the individual 10, such as the area around the mouth 16. The fourth data 288 may include data of the external features at the bite position, such as when the individual 10 is smiling or grimacing. However, the arches 12, 14 will typically not be visible in the fourth data 288.

Capturing empirical data of the external features 18 while the individual 10 is at a selected facial expression facilitates modelling of the individual 10 at that facial expression based on empirical data. In addition, acquiring data of other external features, such as the position of the external auditory meatus, among other landmarks, facilitates more accurate modelling of jaw movements. Facial Information may be capture in the fourth data 288, and also in the second data 286, if the second data 286 is captured with an extraoral scanner, which may involve use of cheek retractors. Additionally, information obtained by scanning portions of the individual's dentures (such as through the appliance data 89), modified replicas (such as the replica 20), or the maxillary and mandibular trays 17, 19 (such as the third data 187) may provide esthetic information which can be used to assist design of dentures or other appliances, particularly when used in combination with data of the external features 18.

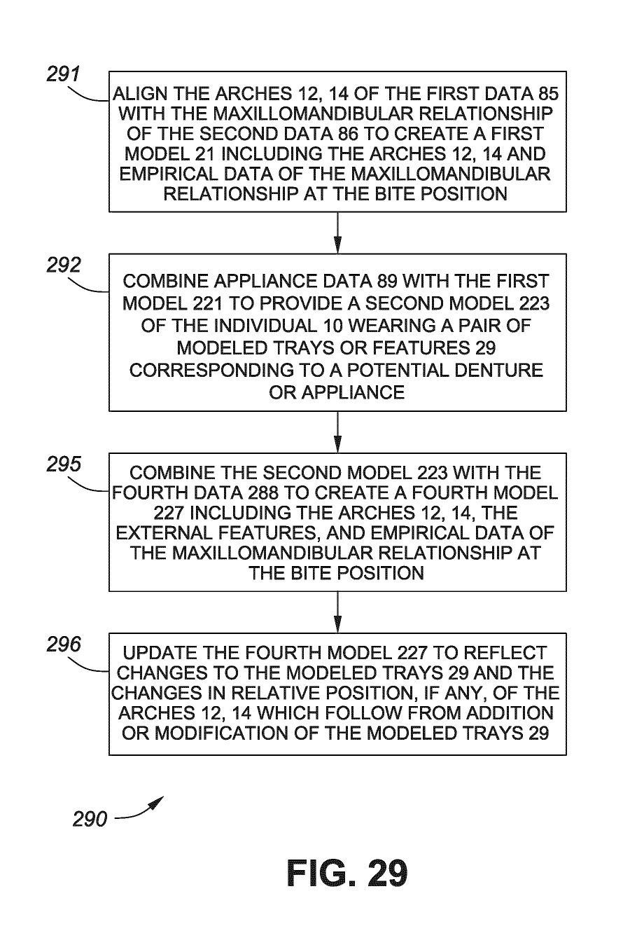

FIG. 29 is a flow chart of a processing method 290 for assembling the first data 285, second data 286, and fourth data 288 into a fourth model 227 which includes data of the external features 18.

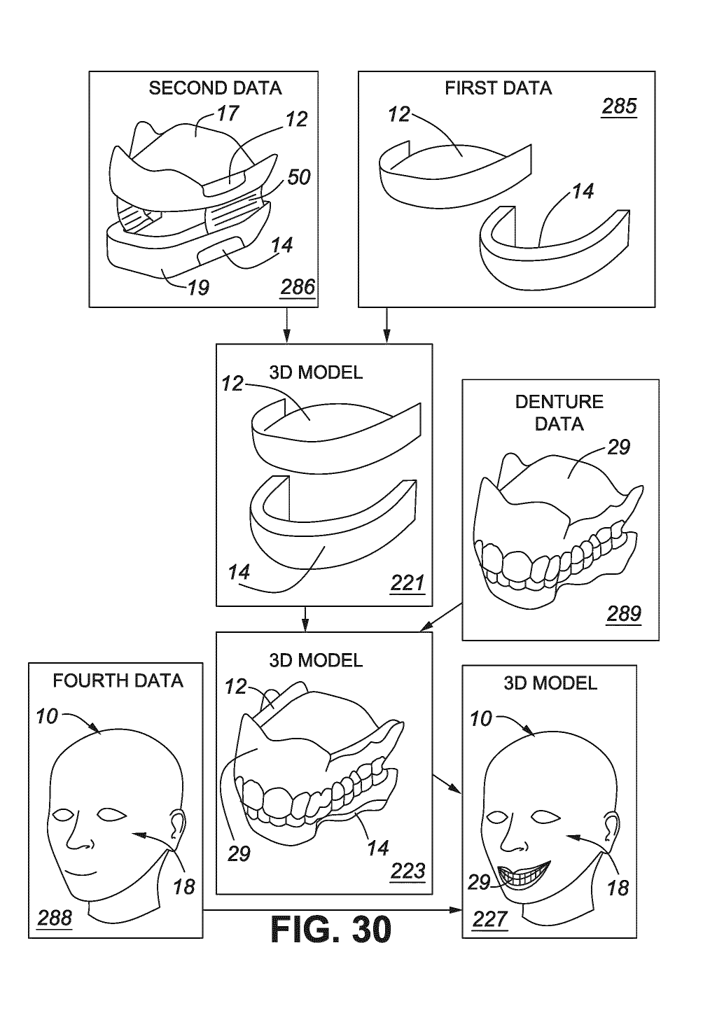

FIG. 30 is a schematic of the components of the fourth model 227. When maxillomandibular relationship or the modeled trays of the fourth model 227 are updated, the external features are also updated in response at 296. Facial information is recorded with an extraoral 3D scan of the individual's head. Useful information for esthetic design of dental restorations and prostheses design includes, but is not limited to; resting lip position with mouth open, resting lip position with jaws at rest and mouth closed, resting lip position in bite with mouth closed, high smile line of lips. Dentures affect the lip position much more significantly than natural dentition does, as dentures incorporate support flanges which cover the maxillary gums, and provide lip support. With the loss of front teeth and their supporting structures of bone and tissues, lip support is insufficient and commonly has a completely collapsed appearance. Taking an extraoral scan of an individual without dentures, may result in a poor visualisation of future designs, as the lack of lip support would result in a dissimilar appearance of the new prosthesis, compared to the design visualized by the software.

Facial information may include, but is not limited to the following landmarks:

A. Sagittal or Median Plane—An imaginary plane that passes longitudinally through the middle of the head and divides it into right and left halves

B. Locations of the ear canals, also known as the external auditory meatus

C. Borders of the Ala of the Nose

D. Borders of the Tragus/Tragion of the Ears

E. Orbits of the eyes

F. Orbitales, identified by visible marks on the skin

G. Menton, identified by visible marks on the skin

H. Glabella, identified by visible marks on the skin

I. Nasion, identified by visible marks on the skin

J. Pogonion, identified by visible marks on the skin

K. Gonion, identified by visible marks on the skin

L. Gnathion, identified by visible marks on the skin

M. Position of lips in a relaxed state, known as ‘lip line’

N. Position of lips during smiling, known as ‘smile line’

O. Position of lips in bite

P. Side profile. Straight, concave or convex.

Q. Facial profile. Square, Round, Tapered

Following the identification of the relevant landmarks from above, the following points may be established:
Beyron point—about 13 mm anterior to the posterior margin of the tragus of the ear on a line from the center of tragus extending to the corner of the eye
Bergstrom point—about 10 mm anterior to the center of the spherical insert for the external auditory meatus and about 7 mm below the Frankfort horizontal plane
Gysi point—about 13 mm in front of the most upper part of the external auditory meatus on a line passing to the outer canthus of the eye.
Frankfort horizontal plane—A plane passing through the inferior margin of the orbit (the point called the orbitale) and the upper margin of each ear canal or external auditory meatus
Campers plane—A line running from the inferior border of the ala of the nose to some defined point on the tragus of the ear, usually the midpoint or superior border of the tragus. It is frequently used, for the purpose of establishing the ala tragus plane. Ideally the alatragus plane is considered to be parallel to the occlusal plane. The occlusal plane is at an angle of approximately 10 degrees relative to the Frankfort horizontal plane when viewed in the mid-sagittal plane.

Replica with Bridging Dentition

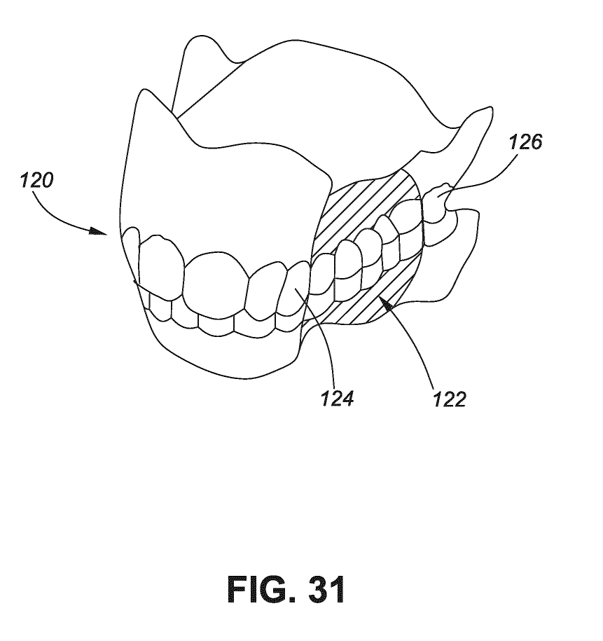

FIG. 31 is a replica 120 of a denture. The anterior dentition 124 and posterior dentition 126 extend across the aperture 122, providing a frame of reference close to the aperture 122 for the continuous path.

Aperture Locations

The apertures which provide a view of the arches may be placed at various positions on the pin tracer or other trays which are used to establish a bite and scan the arches. Some examples follow below.

FIG. 32 is a pin tracer 700 with a single maxillary buccal facial aperture 742 and single mandibular buccal facial aperture 746. The maxillary buccal facial aperture 742 and mandibular buccal facial aperture 746 are on opposite sides of the respective maxillary and mandibular components 732, 734. The continuous path would extend between the apertures 742, 746 for a greater distance than in the pin tracer 30. Generally, locating the apertures on corresponding sides of the respective maxillary and mandibular arches facilities scanning more so than placing the apertures on non-corresponding surfaces. For example, the apertures 42, 46 of the pin tracer 30 are located on the left and right sides of both maxillary and mandibular components 32, 34. This provides a simpler continuous path than that of the pin tracer 700.

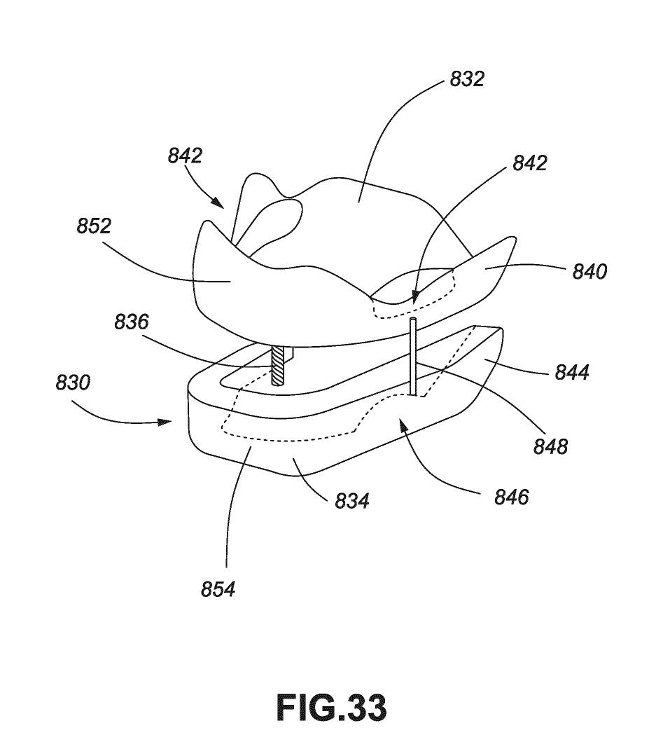

FIG. 33 is a pin tracer 830 with maxillary buccal lingual apertures 851 and mandibular buccal lingual apertures 853. The pin tracer 830 would likely have to be used with an intraoral scanner, as an extra oral scanner would likely not have a clear view of the apertures 851, 853.

FIG. 34 is a pin tracer 930 with maxillary labial facial apertures 941 and mandibular labial facial apertures 943. These locations for the apertures 941 and 943 may be more accessible to scanning than buccal apertures 42, 46, but may also destabilize the pin tracer 930 relative to the pin tracer 30.

FIG. 35 is a pin tracer 1030 with maxillary labial lingual apertures 1045 and mandibular labial lingual apertures 1047. As with the pin tracer 830, lingual apertures may require scanning with an intraoral scanner, as compared with an extra oral scanner.

Examples Only

In the preceding description, for purposes of explanation, numerous details are set forth to provide a thorough understanding of the embodiments. However, it will be apparent to one skilled in the art that these specific details are not required. In some instances, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform portions of a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

1. A method of acquiring data for preparing a model of an edentulous individual comprising:
acquiring first data of a maxillary arch of the individual and of a mandibular arch of the individual for modelling the maxillary arch and the mandibular arch;
providing a pair of components for receiving the maxillary arch and the mandibular arch in a maxillomandibular relationship defining a bite position, the pair of components defining apertures on each of the components for exposing a continuous path between the maxillary arch and the mandibular arch; and
acquiring second data along the continuous path of the maxillary arch and the mandibular arch in the bite position for modelling the relative positions of the maxillary arch and the mandibular arch in the bite position.

2. The method of claim 1 wherein the apertures are aligned on corresponding surfaces of each of the components.

3. The method of claim 1 further comprising combining the first data and the second data to prepare the model, the model including empirical data of the bite position.

4. The method of claim 1 further comprising providing appliance data of a pair of dentures and combining the first data, the second data, and the appliance data to prepare the model, the model including empirical data of the bite position.

5-6. (canceled)

7. The method of claim 1 further comprising acquiring third data of the pair of components for modelling the pair of components.

8. The method of claim 7 further comprising combining the first data, the second data, and the third data to prepare the model, the model including empirical data of the bite position and of the pair of components.

9. The method of claim 1 further comprising acquiring fourth data of external features of the individual for modelling the external features.

10. The method of claim 9 further comprising combining the first data, the second data, and the fourth data to prepare the model, the model including empirical data of the bite position and of the external features at the bite position.

11. (canceled)

12. The method of claim 1, wherein the second data further comprises data of external features of the individual for modelling the relative positions of the maxillary arch and the external features.

13. (canceled)

14. The method of claim 1 wherein providing the pair of components comprises preparing a replica of dentures prepared for the individual and the apertures are defined on the replica.

15. The method of claim 1 further comprising locking the pair of components in the bite position.

16. The method of claim 1, the pair of components further comprising a recorder and a recording surface.

17. The method of claim 16 further comprising defining the bite position with reference to markings made on the recording surface by the recorder.

18. The method of claim 1, further comprising providing a bridge between the pair of components proximate the apertures for providing a frame of reference along a portion of the continuous path located between the pair of components.

19-28. (canceled)

29. A bite registration apparatus comprising:
a maxillary component shaped for receiving a maxillary arch;
a mandibular component shaped for receiving a mandibular arch;
bite establishment components located on facing portions of the maxillary component and the mandibular component for defining a bite between the maxillary component and the mandibular component; and
a maxillary aperture defined on the maxillary component and a mandibular aperture on the mandibular component for exposing to scanning a continuous path between a maxillary arch received within the maxillary component and a mandibular arch received within the mandibular component.

30. The bite registration apparatus of claim 29 wherein the maxillary aperture and the mandibular aperture are defined on corresponding surfaces of the maxillary component and of the mandibular component.

31-34. (canceled)

35. The bite registration apparatus of claim 29 further comprising a bridge extending between the maxillary component proximate the maxillary aperture and the mandibular component proximate the mandibular aperture for providing a frame of reference along the continuous path between the maxillary component and the mandibular component.

36. The bite registration apparatus of claim 35 wherein the bridge comprises a bridge component movable between a closed position and a bridging position.

37-39. (canceled)

40. The bite registration apparatus of claim 36 wherein the bridge component reversibly covers at least one of the apertures.

41. The bite registration apparatus of claim 29 wherein the complementary bite establishment components comprise dentition extending from the maxillary component and from the mandibular component.

42. The bite registration apparatus of claim 29 wherein the complementary bite establishment components comprise a recording surface and an opposed recorder for marking the recording surface.

43. The bite registration apparatus of claim 42 wherein the recorder extends from the mandibular component and the recording surface is located on the maxillary component.

44. The bite registration apparatus of claim 42 wherein the complementary bite establishment components comprise dentition.

45-46. (canceled)

47. A method of acquiring data for preparing a model of an edentulous individual comprising:
acquiring first data of a maxillary arch of the individual and of a mandibular arch of the individual for modelling the maxillary arch and the mandibular arch;
providing a pair of components for receiving the maxillary arch and the mandibular arch in a maxillomandibular relationship defining a bite position, the pair of components comprising bite establishment components for defining the bite position, and the pair of components defining apertures on opposite buccal sides of each of the components for exposing a continuous path between the opposite buccal sides of the maxillary arch and the mandibular arch; and
acquiring second data along the continuous path of the maxillary arch and the mandibular arch in the bite position for modelling the relative positions of the maxillary arch and the mandibular arch in the bite position.

48. The method of claim 47 wherein the bite establishment components comprise dentition extending from each of the components.

49. The method of claim 47 wherein the bite establishment components comprise a recorder and an opposed recorder for marking the recording surface.

50. The method of claim 49 further comprising defining the bite position with reference to markings made on the recording surface by the recorder.

51. The method of claim 47 further comprising providing a bridge between the pair of components for providing a frame of reference along a portion of the continuous path located between the pair of components.

52. The method of claim 47 wherein providing the pair of components comprises preparing a replica of dentures prepared for the individual, the bite establishment components are located on the replica, and the apertures are defined on the replica.

53. A bite registration apparatus comprising:
a maxillary component shaped for receiving a maxillary arch;
a mandibular component shaped for receiving a mandibular arch;
bite establishment components located on facing portions of the maxillary component and the mandibular component for defining a bite between the maxillary component and the mandibular component; and
a maxillary aperture defined on a first buccal side of the maxillary component and a mandibular aperture on a second buccal side of the mandibular component, the first buccal side opposite the second buccal side, for exposing to scanning a continuous path between the first buccal side of a maxillary arch received within the maxillary component and the second buccal side of a mandibular arch received within the mandibular component.

54. The bite registration apparatus of claim 53 wherein the complementary bite establishment components comprise dentition extending from the maxillary component and from the mandibular component.

55. The bite registration apparatus of claim 53 wherein the complementary bite establishment components comprise a recording surface and an opposed recorder for marking the recording surface.

56. The bite registration apparatus of claim 55 wherein the complementary bite establishment components comprise dentition.

57. The bite registration apparatus of claim 53 further comprising a bridge extending between the maxillary component and the mandibular component for providing a frame of reference along the continuous path between the maxillary component and the mandibular component.
